(19) United States
(12) Patent Application Publication
(10) Pub. No.: US 2017/0358268 A1
(43) Pub. Date: Dec. 14, 2017

(54) DATA SIGNAL LINE DRIVE CIRCUIT, DISPLAY DEVICE PROVIDED WITH SAME, AND METHOD FOR DRIVING SAME

(71) Applicant: Sharp Kabushiki Kaisha, Sakai City, Osaka (JP)

(72) Inventors: Masaaki NISHIO, Sakai City (JP); Hongbing WENG, Sakai City (JP); Norio OHMURA, Sakai City (JP)

(21) Appl. No.: 15/531,376

(22) PCT Filed: Nov. 20, 2015
(86) PCT No.: PCT/JP2015/082676

§ 371 Date: May 26, 2017

(30) Foreign Application Priority Data
Nov. 28, 2014 (JP) 2014-241965

(51) Int. Cl. G09G 3/36; G09G 3/20

(52) U.S. Cl. CPC G09G 3/3688; G09G 3/3655; G09G 3/3696; G09G 3/2011; G09G 2310/0283; G09G 2310/0297; G09G 2300/0408

(57) ABSTRACT

Provided is a display device and the like, in which power consumption is reduced in consideration of increased definition of a display image or an increased size of a display panel. In a liquid crystal display device having a power-saving mode in addition to a normal mode, buffers for outputting data signals from a source driver (300) to source lines are made up of positive-polarity buffers (333p) and negative-polarity buffers (333n), and a connection switching circuit 334 is provided between output ends of these buffers and the source driver (300). In the power-saving mode, the buffers (333p, 333n) are connected to source lines by the connection switching circuit (334), while the polarities of the buffers are taken into account, such that the same data signals are applied to two mutually adjacent source lines. Accordingly, although horizontal resolution is halved, half of the buffers in the source driver (300) are halted, thereby enabling great reduction in power consumption.

### TECHNICAL FIELD

The present invention relates to a display device such as an active matrix-type liquid crystal display device, and more specifically relates to a data signal line drive circuit of such a display device, and a method for driving the same.

### BACKGROUND ART

In a liquid crystal display device, in order to prevent deterioration in liquid crystal, alternate current (AC) drive is performed on a liquid crystal panel, and a polarity of a voltage applied to a liquid crystal layer of the liquid crystal panel is usually reversed in each frame period. In an active matrix-type liquid crystal display device, in order to prevent degradation of the quality of display by the AC drive, a drive system is often adopted to apply a voltage with a different polarity to pixel formation portions that are mutually adjacent horizontally or vertically among a plurality of pixel formation portions arranged in a matrix on the liquid crystal panel (hereinafter referred to as a “pixel matrix”). Among the AC drive systems, a system in which the liquid crystal panel is driven such that a polarity of a voltage applied to a pixel formation portion is reversed for each one or a predetermined number of pixel rows is referred to as a “line-reversal drive system”, a system in which the liquid crystal panel is driven such that a polarity of a voltage applied to a pixel formation portion is reversed for each one or a predetermined number of pixel columns is referred to as a “source-reversal drive system” or a “column-reversal drive system”, and a system in which the liquid crystal panel is driven such that a polarity of a voltage applied to a pixel formation portion is reversed for each one or a predetermined number of pixel rows and a polarity of a voltage applied to a pixel formation portion is also reversed for each one or a predetermined number of pixel columns is referred to as a “dot-reversal drive system.” The “pixel row” as used herein means a row made up of pixel formation portions arrayed horizontally (in an extending direction of the scanning signal line) in the pixel matrix, and the “pixel column” as used herein means a column made up of pixel formation portions arrayed vertically (in an extending direction of a data signal line) in the pixel matrix.

In the active matrix-type liquid crystal display device, a plurality of data signal lines and a plurality of scanning signal lines that intersect with the plurality of data signal lines are disposed on the liquid crystal panel, and each pixel formation portion corresponds to one of the plurality of data signal lines and corresponds to one of the plurality of scanning signal lines. When a corresponding scanning signal line is selected, each pixel formation portion takes in a data signal that is an analog voltage to be applied to the corresponding data signal line, and a voltage corresponding to the data signal is applied to a liquid crystal layer in the pixel formation portion. By such voltage application controlling a light transmittance of the liquid crystal layer, an image is displayed on the liquid crystal panel.

In the active matrix-type liquid crystal display device as described above, in order to reduce power required for AC drive, the following configuration is known and has been put in practice: two types of source amplifiers, which are an amplifier for generating a positive-polarity analog voltage (hereinafter referred to as a “positive-polarity buffer”) and an amplifier for generating a negative-polarity analog voltage (hereinafter referred to as a “negative-polarity buffer”), are used as an amplifier (also referred to as a “source amplifier” for generating a data signal to be applied to each data signal line, and the source amplifier connected to the data signal line is switched between the positive-polarity buffer and the negative-polarity buffer in accordance with the polarity of the data signal (analog voltage) to be applied to each data signal line. Since an amplitude of a voltage to be handled is low in the positive-polarity buffer and the negative-polarity buffer as compared with that in a bipolar buffer, it is possible to use an element with a low breakdown voltage, and thus reduce a chip area of an IC (Integrated Circuit) including the buffer. There is also known a liquid crystal display device configured such that, when the source-reversal drive system or the dot-reversal drive system is to be adopted, a positive-polarity buffer and a negative-polarity buffer respectively connected to mutually adjacent data signal lines are switched to each other in accordance with switching of the polarities of data signals to be applied to those data signal lines (e.g., see Patent Documents 1, 2).

### PRIOR ART DOCUMENTS

### Patent Documents

[Patent Document 1] Japanese Laid-Open Patent Publication No. H10-62744

[Patent Document 2] Japanese Laid-Open Patent Publication No. 2010-122587

### SUMMARY OF THE INVENTION

### Problems to be Solved by the Invention

In active-matrix-type display devices such as liquid crystal display devices, definition of a display image and a size of a display panel are increased with the passing of the years. This increases the number of source amplifiers and a load of each source amplifier, thus leading to an increase in power consumption of the display device, particularly, power consumption of a data signal line drive circuit.

Accordingly, an object of the present invention is to provide a data signal line drive circuit of an active matrix-type display device in which power consumption is reduced in consideration of increased definition of a display image or an increased size of a display panel, and to provide a method for driving the display device.

### Means for Solving the Problems

A first aspect of the present invention provides a data signal line drive circuit of a display device which has at least two operation modes including a normal mode and a power-saving mode, and includes a plurality of data signal lines, a plurality of scanning signal lines that intersect with the plurality of data signal lines, and a plurality of pixel formation portions arranged in a matrix along the plurality of data signal lines and the plurality of scanning signal lines, the data signal line drive circuit including:

a data signal generation unit configured to generate a plurality of internal data signals, which show voltages or currents to be applied to the plurality of data signal lines, based on an externally inputted image signal; and

an output buffer unit including a plurality of buffers that are provided so as to correspond to the plurality of data signal lines and configured to output the plurality of internal data signals as a plurality of data signals to be applied to the plurality of data signal lines,

wherein the output buffer unit is configured such that

in the normal mode, the plurality of buffers output the plurality of data signals to be applied to the plurality of data signal lines, and

in the power-saving mode, at least part of the plurality of buffers are operated so as to apply the same data signals to two or a greater predetermined number of pixel formation portions that are adjacent in an extending direction of the data signal line or in an extending direction of the scanning signal line, and

among the plurality of buffers, buffers other than buffers outputting data signals to be applied to any of the plurality of data signal lines are halted, or the plurality of buffers are halted in a period in which the plurality of data signals are not applied to the plurality of data signal lines.

A second aspect of the present invention provides the data signal line drive circuit according to the first aspect of the present invention, further including a connection switching circuit configured to switch connection between the plurality of buffers and the plurality of data signal lines,

wherein the connection switching circuit
connects each of the plurality of buffers to a corresponding data signal line in the normal mode, and
connects each of part of the plurality of buffers to a corresponding data signal line and other one or more data signal lines that are adjacent to the corresponding data signal line or within a predetermined range in the power-saving mode, and

the output buffer unit is configured so as to halt buffers that are not connected to any of the plurality of data signal lines, among the plurality of buffers, in the power-saving mode.

A third aspect of the present invention provides the data signal line drive circuit according to the second aspect of the present invention, wherein

the display device is a display device of an AC drive system,

the plurality of buffers are made up of two types of buffers including a positive-polarity buffer that outputs a positive-polarity data signal and a negative-polarity buffer that outputs a negative-polarity data signal,

the connection switching circuit
connects the plurality of buffers to the plurality of data signal lines and switches connection between the plurality of buffers and the plurality of data signal lines in accordance with reversal of polarities of the plurality of data signals to be applied to the plurality of data signal lines such that a polarity of each of the buffers matches a polarity of a data signal to be applied to a data signal line to be connected with the relevant buffer,
connects each of the buffers to one data signal line of a corresponding data signal line and other one data signal line that is adjacent to the corresponding data signal line or within a predetermined range, and switches the data signal line connected with each of the buffers between the corresponding data signal line and the other one data signal line in accordance with reversal of the polarities, in the normal mode, and
connects each of part of the plurality of buffers to a corresponding data signal line and other one or more data signal lines that are adjacent to the corresponding data signal line or within a predetermined range, and switches the buffer connected to each of the data signal lines between the plurality of buffers in accordance with reversal of the polarities, in the power-saving mode, and

the output buffer unit is configured so as to halt buffers that are not connected to any of the plurality of data signal lines, among the plurality of buffers in the power-saving mode.

A fourth aspect of the present invention provides the data signal line drive circuit according to the third aspect of the present invention, wherein

the plurality of buffers are configured such that polarities of two buffers corresponding to two mutually adjacent data signal lines are different from each other,

the connection switching circuit
groups the two mutually adjacent data signal lines as one set,
connects one of the two buffers corresponding to two data signal lines of each set to one of the two data signal lines, while connecting the other of the two buffers to the other of the two data signal lines, and switches connection between the two buffers and the two data signal lines in accordance with reversal of the polarities, in the normal mode, and
connects one of two buffers corresponding to two data signal lines of each set to both of the two data signal lines, and switches the buffer connected with the two data signal lines between the two buffers in accordance with reversal of the polarities, in the power-saving mode.

A fifth aspect of the present invention provides the data signal line drive circuit according to the third aspect of the present invention, wherein the data signal generation unit is configured so as to halt a circuit of at least part of a portion corresponding to generation of an internal data signal to be inputted into a buffer being halted among the plurality of buffers in the power-saving mode.

A sixth aspect of the present invention provides the data signal line drive circuit according to the fifth aspect of the present invention, wherein

the data signal generation unit includes

a data shift unit configured to receive the image signal as digital data in a serial format and convert the digital data in the serial format to digital data in a parallel format, and

a DA conversion unit configured to convert the digital data in the parallel format to analog data corresponding to the plurality of internal data signals, and

in the power-saving mode, the data signal generation unit halts a circuit of a portion in at least one of the data shift unit and the DA conversion unit, the portion corresponding to generation of an internal data signal to be inputted into the buffer being halted.

A seventh aspect of the present invention provides a display device including:

the data signal line drive circuit according to any one of the first to sixth aspects of the present invention; and

a scanning signal line drive circuit configured to selectively drive the plurality of scanning signal lines.

A eighth aspect of the present invention provides the display device according to the seventh aspect of the present invention, wherein

the scanning signal line drive circuit
drives the plurality of scanning signal lines such that the plurality of scanning signal lines are selected one at a time in the normal mode, and
drives the plurality of scanning signal lines such that the plurality of scanning signal lines are selected in a predetermined number of two or more, at a time, and a selection period in which any of the scanning signal lines is selected and a non-selection period in which none of the scanning signal lines is selected alternately appear, in the power-saving mode, and

the output buffer unit is configured so as to halt the plurality of buffers during the non-selection period in the power-saving mode.

A ninth aspect of the present invention provides a display device for displaying a color image based on primary colors in a predetermined number of three or more, the display device including:

the data signal line drive circuit according to any one of the second to sixth aspects of the present invention; and

a scanning signal line drive circuit configured to selectively drive the plurality of scanning signal lines,

wherein each of pixel formation portions includes a predetermined number of sub-pixel formation portions corresponding to the predetermined number of primary colors and arranged in an extending direction of the scanning signal line,

each of the sub-pixel formation portions corresponds to one of the plurality of data signal lines and corresponds to one of the plurality of scanning signal lines, and

in the power-saving mode, the connection switching circuit connects each of part of the plurality of buffers to a corresponding data signal line and a data signal line that is located adjacent to the corresponding data signal line or within a predetermined range and corresponds to a sub-pixel formation portion of the same color.

A tenth aspect of the present invention provides a display device for displaying a color image based on primary colors in a predetermined number of three or more, the display device including:

the data signal line drive circuit according to any one of the second to sixth aspects of the present invention;

a scanning signal line drive circuit configured to selectively drive the plurality of scanning signal lines; and

a demultiplexing circuit provided inside or outside the data signal line drive circuit and includes a plurality of demultiplexers corresponding to the plurality of data signals,

wherein each of pixel formation portions includes a predetermined number of sub-pixel formation portions corresponding to the predetermined number of primary colors and arranged in an extending direction of the scanning signal line,

each of the sub-pixel formation portions corresponds to one of the plurality of data signal lines and corresponds to one of the plurality of scanning signal lines,

each of the plurality of data signal lines is connected with a sub-pixel formation portion of one of the predetermined number of primary colors, each data signal line corresponding to one of the predetermined number of primary colors, and

each of the demultiplexers is connected to one set of data signal line group among a plurality of sets of data signal line groups, provides a corresponding data signal to any one data signal line of the one set, and switches the data signal line provided with the corresponding data signal within the one set, the plurality of sets of data signal line groups being obtained by grouping the plurality of data signal lines while regarding a predetermined number of data signal lines that correspond to the predetermined number of primary colors as one set.

Description of the other aspects of the present invention is omitted since those aspects are apparent from the description of the first to tenth aspects of the present invention described above and from the description of each of embodiments and variants thereof described below.

### Effects of the Invention

According to the first aspect of the present invention, in the normal mode, an image is displayed with resolution corresponding to a plurality of pixel formation portions arranged in a matrix, whereas in the power-saving mode, at least part of buffers in the data signal line drive circuit are operated so as to provide the same data signals to two or a greater predetermined number of pixel formation portions that are adjacent in the extending direction of the scanning signal line (horizontal direction) or in the extending direction of the data signal line (vertical direction), and among the buffers in the data signal line drive circuit, buffers other than buffers outputting data signals to be applied to any of the data signal lines is halted, or the buffers in the data signal line drive circuit (all buffers) are halted in a period in which no data signal is applied to any of data signal lines. Hence in the power-saving mode, as compared with the normal mode, the horizontal resolution (in the extending direction of the scanning signal line) or the vertical resolution (in the extending direction of the data signal line) decreases, but the power consumption is reduced greatly. In recent years, while resolution of a matrix display device is increasingly improved, reduction in power consumption is strongly required when such a display device is used in a mobile device. Accordingly, having the power-saving mode capable of greatly reducing the power consumption even though the resolution decreases as described above is a great advantage over the conventional display device.

According to the second aspect of the present invention, in the normal mode, each of the buffers in the data signal line drive circuit is connected to a corresponding data signal line, whereas in the power-saving mode, each of part of the buffers in the data signal line drive circuit is connected to a corresponding data signal line and other one or more data signal lines that are adjacent to the corresponding data signal line or within a predetermined range, and buffers that are not connected to any of the data signal lines come into a halted state. Hence in the power-saving mode, as compared with the normal mode, the horizontal resolution (in the extending direction of the scanning signal line) decreases, but the power consumption is reduced greatly.

According to the third aspect of the present invention, in order to display an image by the AC drive system, two types of buffers including a positive-polarity buffer and a negative-polarity buffer are used in the data signal line drive circuit, and the buffers in the data signal line drive circuit are connected to data signal lines and this connection is switched in accordance with reversal of polarities of data signals such that a polarity of each of the buffers matches a polarity of a data signal to be applied to a data signal line to be connected with the relevant buffer. As for the connection between the buffers in the data signal line drive circuit and the data signal lines, in the normal mode, each of the buffers is connected to one data signal line of a corresponding data signal line and the other one data signal line that is adjacent to the corresponding data signal line or within the predetermined range, whereas in the power-saving mode, each of part of the buffers in the data signal line drive circuit is connected to a corresponding data signal line and other one or more data signal lines that are adjacent to the corresponding data signal line or within the predetermined range, and buffers that are not connected to any of the plurality of data signal lines come into the halted state. Hence in the power-saving mode, as compared with the normal mode, the horizontal resolution (in the extending direction of the scanning signal line) decreases, but the power consumption is reduced greatly. According to the present aspect, since the AC drive is performed using the two types of buffers that are the positive-polarity buffer and the negative-polarity buffer, the power consumption and the buffer size can be reduced more than in the case of performing the AC drive by one type of buffer.

According to the fourth aspect of the present invention, the buffers in the data signal line drive circuit are configured such that polarities of two buffers corresponding to two mutually adjacent data signal lines are different from each other, and in the normal mode, one of two buffers corresponding to two data signal lines of each set, obtained by grouping two mutually adjacent data signal lines as one set, is connected to one of the two data signal lines, whereas in the power-saving mode, one of two buffers corresponding to two data signal lines of each set is connected to both of the two data signal lines, and buffers that are not connected to any of the data signal lines come into the halted state. Thus, an image is displayed by the AC drive system with the polarity of the data signal being different for each data signal line (e.g. the source-reversal drive system or the dot-reversal drive system), and in the power-saving mode, as compared with the normal mode, the horizontal resolution (in the extending direction of the scanning signal line) decreases, but the power consumption is reduced greatly. According to the present aspect, since the AC drive is performed using the two types of buffers that are the positive-polarity buffer and the negative-polarity buffer, the power consumption and the buffer size can be reduced more than in the case of performing the AC drive by one type of buffer, and further, applying the connection switching circuit used in the normal mode also to the power-saving mode can prevent an increase in amount of circuit for achieving the power-saving mode.

According to the fifth aspect of the present invention, in the power-saving mode, in addition to halting the buffers that are not connected to any of the data signal lines, the data signal generation unit halts a circuit of at least part of a portion corresponding to generation of an internal data signal to be inputted into a buffer being halted. Hence in the power-saving mode, the power consumption is reduced further greatly as compared with the normal mode.

According to the sixth aspect of the present invention, in the power-saving mode, in addition to halting the buffers that are not connected to any of the data signal lines, the data signal generation unit halts a circuit of a portion corresponding to generation of an internal data signal to be inputted into the buffer being halted, in at least one of the data shift unit and the DA conversion unit, thereby making it possible to obtain a similar effect to that of the fifth aspect of the present invention.

According to the seventh aspect of the present invention, in a display device provided with a plurality of data signal lines, a plurality of scanning signal lines that intersect with the plurality of data signal lines, and a plurality of pixel formation portions arranged in a matrix along the plurality of data signal lines and the plurality of scanning signal lines, similar effects to those of the first to sixth aspects of the present invention are obtained.

According to the eighth aspect of the present invention, in the normal mode, the plurality of scanning signal lines in the display device are selected one at a time, whereas in the power-saving mode, the plurality of scanning signal lines are selected in a predetermined number of two or more, at a time, and a selection period in which any (a plurality of) scanning signal lines are selected and a non-selection period in which no scanning signal line is selected alternately appear, and the buffers in the data signal line drive circuit are halted during the non-selection period. Hence in the power-saving mode, as compared with the normal mode, the vertical resolution (in the extending direction of the data signal line) decreases, but the power consumption is reduced greatly.

According to the ninth aspect of the present invention, in a display device where each of pixel formation portions includes a predetermined number of sub-pixel formation portions corresponding to a predetermined number, three or more, of primary colors and arranged in the extending direction of the scanning signal line, in the power-saving mode, each of part of the buffers in the data signal line drive circuit is connected to a corresponding data signal line and a data signal line that is located adjacent to the corresponding data signal line or within a predetermined range and corresponds to a sub-pixel formation portion of the same color. Thus, while a color image based on the predetermined number of primary colors is displayed, the buffers that are not connected to any of the data signal lines in the data signal line drive circuit are halted in the power-saving mode, to cause a decrease in horizontal resolution, but enable great reduction in power consumption as compared with the normal mode.

According to the tenth aspect of the present invention, in a display device where each of pixel formation portions includes a predetermined number of sub-pixel formation portions corresponding to a predetermined number, three or more, of primary colors and arranged in the extending direction of the scanning signal line, and each of the plurality of data signal lines is connected with a sub-pixel formation portion of any one of the predetermined number of primary colors, each of demultiplexers is connected to any one set of data signal line group among a plurality of sets of data signal line groups, obtained by grouping the data signal lines while regarding a predetermined number of data signal lines that correspond to the predetermined number of primary colors as one set, provides a corresponding data signal to any one data signal line of the one set, and switches the data signal line provided with the corresponding data signal within the one set. In the display device for displaying a color image by a so-called SSD (Source Shared Drive) system as thus described, in the power-saving mode, each of part of the buffers in the data signal line drive circuit is connected to a corresponding data signal line and other one or more data signal lines that are adjacent to the corresponding data signal line or within a predetermined range, and buffers that are not connected to any of the plurality of data signal lines come into the halted state. Thus, a color image based on the predetermined number of primary colors is displayed, and in the power-saving mode, as compared with the normal mode, the horizontal resolution decreases, but the power consumption can be reduced greatly.

Description of effects of the other aspects of the present invention is omitted since those effects are apparent from the effects of the first to tenth aspects of the present invention described above and from the description of each of embodiments and variants thereof described below.

### BRIEF DESCRIPTION OF THE DRAWINGS

FIG. 1 is a block diagram showing a configuration of a liquid crystal display device according to a first embodiment of the present invention.

FIG. 2 is a block diagram showing a configuration of a source driver in the first embodiment.

FIG. 3 is a circuit diagram for describing operation of the source driver in a normal mode of the first embodiment.

FIG. 4 is a circuit diagram for describing the operation of the source driver in the normal mode of the first embodiment.

FIG. 5 is a circuit diagram for describing operation of the source driver in a power-saving mode of the first embodiment.

FIG. 6 is a circuit diagram for describing the operation of the source driver in the power-saving mode of the first embodiment.

FIG. 7 is a diagram showing values of signals of the source driver in the respective operation modes of the first embodiment.

FIGS. 8(A) to 8(E) are timing charts showing operation in the normal mode and the power-saving mode of the first embodiment as a comparative example with a second embodiment of the present invention.

FIGS. 9(A) to 9(E) are timing charts showing operation of a liquid crystal display device according to the second embodiment.

FIGS. 10(A) to 10(D) are diagrams for describing resolution in the respective embodiments of the present invention.

FIGS. 11(A) and 11(B) are block diagrams for describing configurations concerning gate drivers in the respective embodiments of the present invention.

FIG. 12 is a circuit diagram for describing a first variant of the first embodiment.

FIG. 13 is a circuit diagram for describing the first variant of the first embodiment.

FIG. 14 is a diagram showing values of signals of a source driver in the respective operation modes of the first variant.

FIG. 15 is a circuit diagram for describing a second variant of the first embodiment.

FIG. 16 is a circuit diagram for describing a third variant of the first embodiment.

FIG. 17 is a circuit diagram for describing a configuration and operation in a normal mode of a fourth variant of the first embodiment.

FIG. 18 is a circuit diagram for describing a configuration and operation in the normal mode of the fourth variant.

FIG. 19 is a circuit diagram for describing a configuration and operation in a power-saving mode of the fourth variant.

FIG. 20 is a circuit diagram for describing a configuration and operation in the power-saving mode of the fourth variant.

FIG. 21 is a diagram showing values of signals of the source driver in the fourth variant.

FIG. 22 is a circuit diagram for describing a fifth variant of the first embodiment.

FIG. 23 is a circuit diagram for describing a sixth variant of the first embodiment.

### MODES FOR CARRYING OUT THE INVENTION

### 1. First Embodiment

<1.1 Overall Configuration>

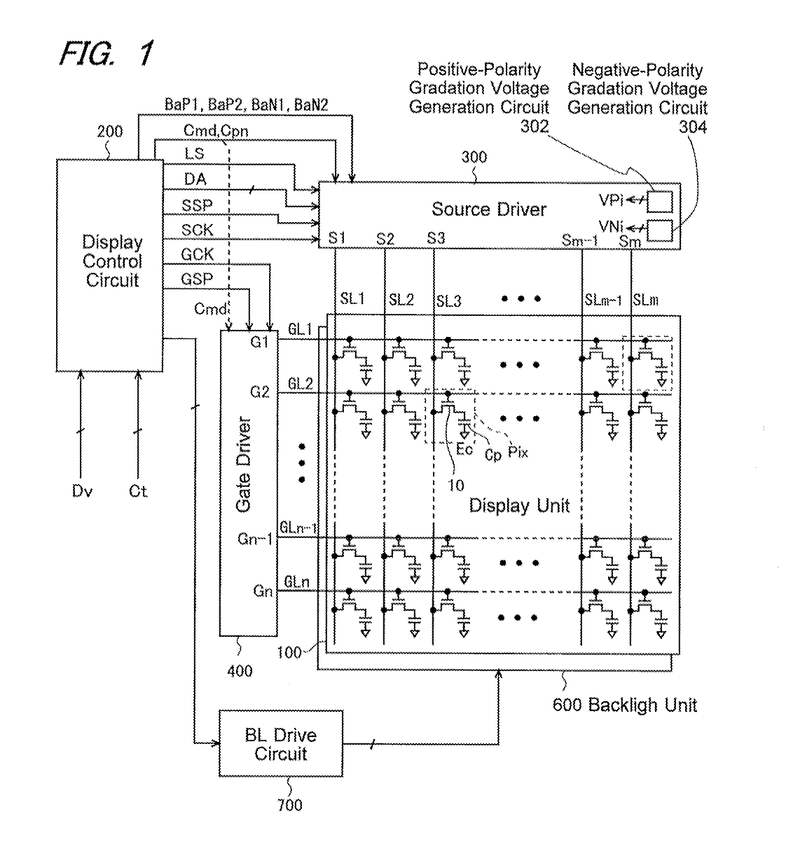

FIG. 1 is a block diagram showing a configuration of a liquid crystal display device, along with an equivalent circuit of its display unit, according to a first embodiment of the present invention. This liquid crystal display device includes a source driver 300 as a data signal line drive circuit, a gate driver 400 as a scanning signal line drive circuit, an active matrix-type display unit 100, a backlight 600, a BL drive circuit 700 for driving the backlight, and a display control circuit 200 for controlling the source driver 300, the gate driver 400, and the BL drive circuit 700. In the present embodiment, although the display unit 100 is implemented as an active matrix-type liquid crystal panel, the display unit 100 may be integrated with one or both of the source driver 300 and the gate driver 400 to constitute a liquid crystal panel.

The display unit 100 in the liquid crystal display device includes gate lines GL1 to GLn as a plurality of (n) scanning signal lines, source lines SL1 to SLm as a plurality of (m) data signal lines that intersect with each of the gate lines GL1 to GLn, and a plurality of (m×n) pixel formation portions Pix that are provided respectively corresponding to intersections of the source lines SL1 to SLm and the gate lines GL1 to GLn. These pixel formation portions Pix are arranged in a matrix to constitute a pixel array, and each pixel formation portion Pix includes: a TFT 10 which is a switching element having a gate terminal connected to a gate line GLj passing through a corresponding intersection, and having a source terminal connected to a source line SLi passing through the intersection; a pixel electrode connected to a drain terminal of the TFT 10; a common electrode Ec which is a counter electrode provided so as to be shared by the plurality of pixel formation portions Pix; and a liquid crystal layer provided so as to be shared by the plurality of pixel formation portions Pix, and sandwiched between the pixel electrode and the common electrode Ec. A liquid crystal capacitance formed by the pixel electrode and the common electrode Ec constitutes a pixel capacitance Cp. Although an auxiliary capacitance is normally provided in parallel with the liquid crystal capacitance so as to reliably hold a voltage in the pixel capacitance, since the auxiliary capacitance is not directly related to the present invention, the description and illustration thereof are omitted. The type of the TFT as a switching element included in each pixel formation portion Pix is not particularly limited, and any of amorphous silicon, polysilicon, microcrystalline silicon, continuous grain silicon (CG silicon), oxide semiconductor, or the like may be used for a channel layer of the TFT. In the following, with reference to the number m of data signal lines, it is assumed that m is a multiple of 2 when “m/2” is mentioned as the number of constituents in each of the embodiments or variants thereof, m is a multiple of 3 when “m/3” is mentioned, m is a multiple of 4 when “m/4” is mentioned, and m is a multiple of 6 when “m/6” is mentioned.

A potential corresponding to an image to be displayed is provided to the pixel electrode in each pixel formation portion Pix by the source driver 300 and the gate driver 400 which operate as described later, and a predetermined potential Vcom is provided to the common electrode Ec from a power supply circuit, not shown. Accordingly, a voltage in accordance with a potential difference between the pixel electrode and the common electrode Ec is applied to the liquid crystal, and an amount of light transmitted through the liquid crystal layer is controlled by this voltage application, to perform image display.

The backlight 600 is a surface illumination device that illuminates the display unit 100 from the back, and is configured by using, for example, a cold-cathode tube or a light emitting diode (LED). This backlight 600 is driven by the BL drive circuit 700 to be lighted, thereby irradiating each pixel formation portion Pix of the display unit 100 with light.

The display control circuit 200 receives an image signal Dv representing an image to be displayed and a timing control signal Ct, and outputs the image signal Dv as a digital image signal DA in units of pixels while generating, based on a timing control signal Ct, various timing control signals for controlling the timing at which an image is displayed on the display unit 100, the timing control signals including a data-side start pulse signal SSP, a data-side clock signal SCK, a latch strobe signal LS, a scanning-side start pulse signal GSP, and a scanning-side clock signal GCK. The display control circuit 200 also generates a signal (hereinafter referred to as a “mode control signal”) Cmd for specifying an operation mode of the liquid crystal display device, a signal (hereinafter referred to as a “polarity control signal”) Cpn for controlling polarities of below-mentioned data signals S1 to Sm that are outputted from the source driver 300, and bias signals BaP1, BaP2, BaN1, BaN2 to be provided to below-mentioned output buffers in the source driver 300. The display control circuit 200 further generates a common potential Vcom to be provided to a common electrode of the display unit 100, and a BL control signal for operating the BL drive circuit 700.

As described above, among the signals that are generated or outputted by the display control circuit 200, the digital image signal DA, the data-side start pulse signal SSP, the data-side clock signal SCK, the latch strobe signal LS, the mode control signal Cmd, the polarity control signal Cpn, and the bias signals BaP1, BaP2, BaN1, BaN2 are provided to the source driver 300, the scanning-side start pulse signal GSP and the scanning-side clock signal GCK are provided to the gate driver 400, the common potential Vcom is provided to (the common electrode Ec of) the display unit 100, and the BL control signal is provided to the BL drive circuit 700. Note that in a second embodiment described later, the mode control signal Cmd is also provided to the gate driver 400.

Based on the digital image signal DA, the data-side start pulse signal SSP, and the data-side clock signal SCK, the source driver 300 sequentially generates, as data signals S1 to Sm, analog voltages corresponding to pixel values on the respective display lines of an image represented by the digital image signal DA, and respectively applies these data signals S1 to Sm to the source lines SL1 to SLm in each one horizontal period. Note that the latch strobe signal LS, the mode control signal Cmd, the polarity control signal Cpn, and the bias signals BaP1, BaP2, BaN1, BaN2 are used for controlling an internal circuit in the source driver 300 for generating the data signals S1 to Sm (described in detail later).

The gate driver 400 generates scanning signals G1 to Gn based on the scanning-side start pulse signal GSP and the scanning-side clock signal GCK, and respectively applies these signals to the gate lines GL1 to GLn, to selectively drive the gate lines GL1 to GLn.

As described above, by the source driver 300 and the gate driver 400 driving the source lines SL1 to SLm and the gate lines GL1 to GLn of the display unit 100, a voltage of the source line SLj is provided to the pixel capacitance Cp via the TFT 10 connected to the selected gate line GLi (i=1 to n, j=1 to m). Accordingly, a voltage in accordance with the digital image signal DA is applied to the liquid crystal layer in each pixel formation portion Pix, and a transmission amount of light from the backlight 600 is controlled by this voltage application to display an image, shown by the digital video signal Dv from the outside, on the display unit 100.

<1.2 Source Driver>

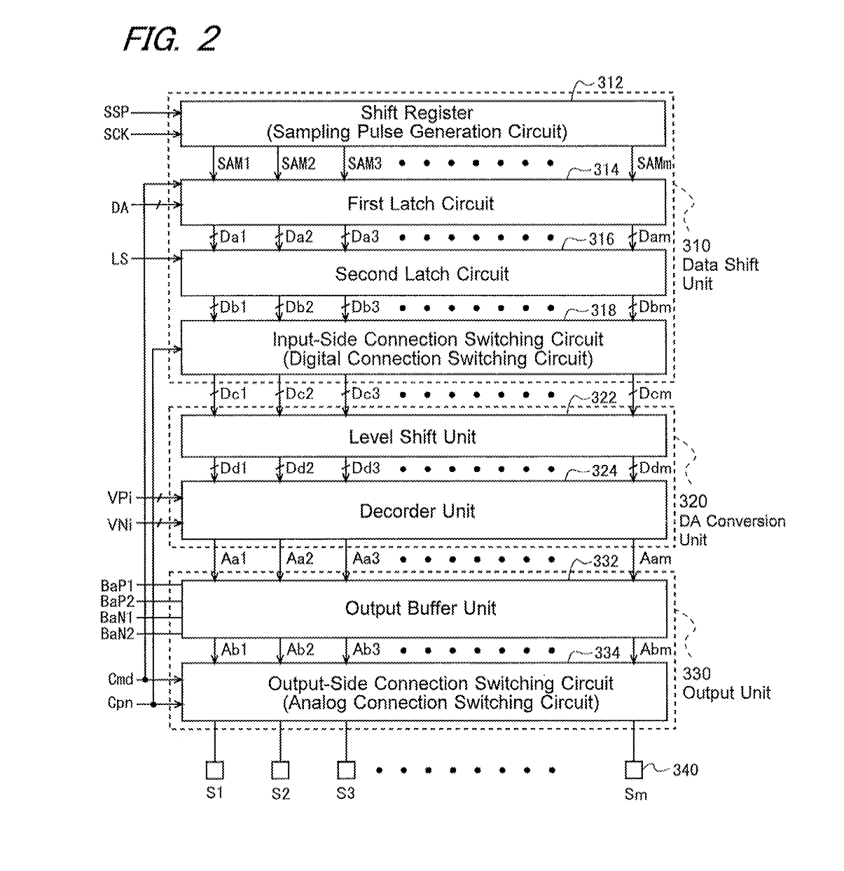

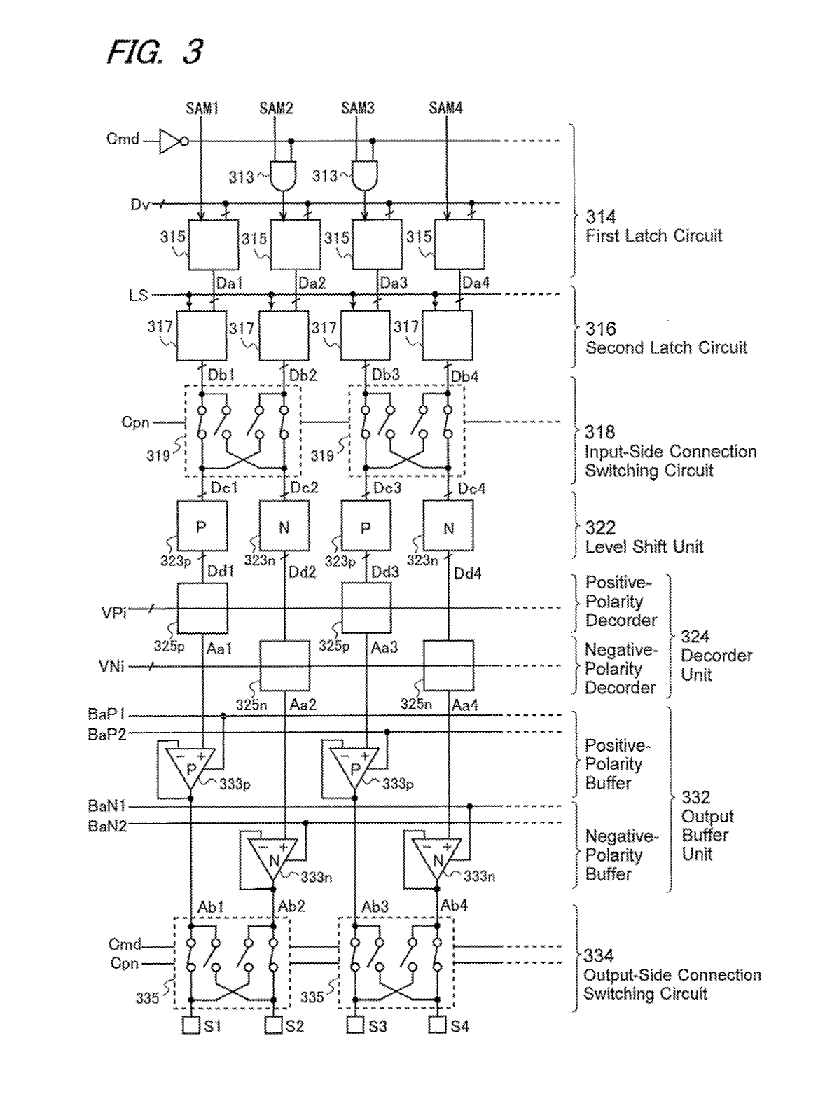

The liquid crystal display device according to the present embodiment has a normal mode and a power-saving mode concerning the operation for displaying an image as described above. Hereinafter, on the premise of the above, the configuration and operation of the source driver 300 in the present embodiment are described with reference to FIGS. 2 and 3.

FIG. 2 is a block diagram showing the configuration of the source driver 300 in the present embodiment, and FIG. 3 is a circuit diagram showing a detailed configuration of part of this source driver 300. As shown in FIG. 2, this source driver 300 includes a data shift unit 310, a DA conversion unit 320, and an output unit 330, and further includes a positive-polarity gradation voltage generation circuit 302 and a negative-polarity gradation voltage generation circuit 304 (cf. the source driver 300 of FIG. 1).

The data shift unit 310 includes a shift register 312, a first latch circuit 314, a second latch circuit 316, and an input-side connection switching circuit 318, and converts digital image data DA serially provided from the display control circuit 200 in units of pixels to parallel data for each data corresponding to one display line, to provide the converted data to a DA conversion unit 320.

On the basis of the data-side clock signal SCK and the data-side start pulse signal SSP from the display control circuit 200, the shift register 312 sequentially transfers one pulse included in the start pulse signal SSP from an input end to an output end in each horizontal period for image display, and sequentially outputs sampling pulses SAM1, SAM2, . . . , SAMm in accordance with this transfer.

By these sampling pulses SAM1, SAM2, . . . , SAMm, the first latch circuit 314 sequentially samples the digital image signal DA from the display control circuit 200. When the digital image signals DA for one line are sampled, first internal digital signals Da1 to Dam, which are the digital image signals DA for one line, are taken and held into the second latch circuit 316 based on the latch strobe signal LS that becomes active in each horizontal period, and the first internal digital signals Da1 to Dam are outputted in parallel as second internal digital signals Db1 to Dbm from the second latch circuit 316 and inputted in parallel into the input-side connection switching circuit 318. As shown in FIG. 3, the first latch circuit 314 includes m latches 315 corresponding to the m data signals S1 to Sm (or m source lines SL1 to SLm), and in addition to these, the first latch circuit 314 includes m/2 AND gates 313 corresponding to a predetermined m/2 data signals among the m data signals S1 to Sm so as to halt an internal circuit that is not used in the power-saving mode (described in detail later). Further, the second latch circuit 316 includes m latches 317 corresponding to the m data signals S1 to Sm.

In accordance with a polarity control signal Spn, the input-side connection switching circuit 318 directly outputs the inputted second internal digital signals Db1 to Dbm as third internal digital signals Dc1 to Dcm, or switches the order of mutually adjacent signals in the inputted second internal digital signals Db1 to Dbm and outputs the obtained signals as third internal digital signals Dc1 to Dcm. That is, the input-side connection switching circuit 318 is made up of m/2 digital signal connection switches 319 as shown in FIG. 3, and when the polarity control signal Spn is 0, the input-side connection switching circuit 318 outputs a second internal digital signal Dbi as the third internal digital signal Dci (i=1, 2, . . . m), and when the polarity control signal Spn is 1, the input-side connection switching circuit 318 outputs an odd-numbered second internal digital signal Db(2j−1) as an even-numbered third internal digital signal Dc(2j) and outputs an even-numbered second internal digital signal Db(2j) as an odd-numbered third internal digital signal Dc(2j−1) (j=1, 2, . . . m/2).

The third internal digital signals Dc1 to Dcm outputted from the input-side connection switching circuit 318 are inputted into the DA conversion unit 320. The DA conversion unit 320 includes a level shift unit 322 and a decoder unit 324. The level shift unit 322 converts a level (voltage) of the third internal digital signals Dc1 to Dcm inputted into the DA conversion unit 320 to a level suitable for the operation of the decoder unit 324, and outputs the signals after the level conversion as fourth internal digital signals Dd1 to Ddm. As described later, the decoder unit 324 is made up of two types of decoders that are a positive-polarity decoder 325p and a negative-polarity decoder 325n, and with a suitable voltage level being different between the positive-polarity decoder 325p and the negative-polarity decoder 325n, the level shift unit 322 is made up of two types of level shifters that are a positive-polarity level shifter 323p for performing a level conversion suitable for the voltage level of the positive-polarity decoder 325p and a negative-polarity level shifter 323n for performing a level conversion suitable for the voltage level of the negative-polarity decoder 325n.

The decoder unit 324 is made up of two types of decoders that are the positive-polarity decoder 325p and the negative-polarity decoder 325n. In the present embodiment, the positive-polarity decoder 325p is provided so as to correspond to each of odd-numbered data signals S1, S3, S(m−1), and the negative-polarity decoder 325n is provided so as to correspond to each of even-numbered data signals S2, S4, Sm in the present embodiment. However, the positive-polarity decoder 325p may be provided so as to correspond to each of the even-numbered data signals S2, S4, Sm, and the negative-polarity decoder 325n may be provided so as to correspond to each of the odd-numbered data signals S1, S3, S(m−1). Each positive-polarity decoder 325p receives a plurality of positive-polarity gradation voltages VP1 to VPq from the positive-polarity gradation voltage generation circuit 302, selects one positive-polarity gradation voltage VPs among the plurality of positive-polarity gradation voltages VP1 to VPq in accordance with the fourth internal digital signal Ddi provided from the corresponding positive-polarity level shifter 323p, and outputs the selected positive-polarity voltage VPs as a first internal analog signal Aai. This first internal analog signal Aai corresponds to a signal after DA conversion of the fourth internal digital signal Ddi (i=1, 3, . . . , m−1). Each negative-polarity decoder 325n receives a plurality of negative-polarity gradation voltages VN1 to VNq from the negative-polarity gradation voltage generation circuit 304, selects one negative-polarity gradation voltage VNs among the plurality of negative-polarity gradation voltages VN1 to VNq in accordance with a fourth internal digital signal Ddj provided from the corresponding negative-polarity level shifter 323n, and outputs the selected negative-polarity voltage VNs as a first internal analog signal Aaj (j=2, 4, . . . , m). First internal analog signals Aa1 to Aam outputted from the positive-polarity decoder 325p and the negative-polarity decoder 325n are provided to the output unit 330.

Since the output unit 330 is made up of the buffer and the connection switching circuit as described below, the first internal analog signals Aa1 to Aam are basically the same signals as the data signals S1 to Sm provided from the source driver 300 to the source lines SL1 to SLm. Hence in the present specification, the first internal analog signals Aa1 to Aam are also referred to as internal data signals. As shown in FIG. 2, since these internal data signals Aa1 to Aam are generated by the data shift unit 310 and the DA conversion unit 320 based on the digital image signal DA, it can thus be said that the data shift unit 310 and the DA conversion unit 320 constitute the data signal generation unit.

The output unit 330 includes an output buffer unit 332 and an output-side connection switching circuit 334. The output buffer unit 332 is made up of two types of buffers that are a positive-polarity buffer 333p and a negative-polarity buffer 333n. These positive-polarity and negative-polarity buffers 333p, 333n each correspond to a source amplifier for outputting a data signal to be applied to the source line. In the present embodiment, the positive-polarity buffer 333p is provided so as to correspond to each of the odd-numbered data signals S1, S3, S(m−1), and the negative-polarity buffer 333n is provided so as to correspond to each of the even-numbered data signals S2, S4, Sm.

As shown in FIG. 3, the positive-polarity buffer 333p functions as a voltage follower for outputting a positive voltage signal (with the common potential Vcom taken as a reference), and each positive-polarity buffer 333p is inputted with the first internal analog signal Aai (i=1, 3, . . . , m−1) from the corresponding positive-polarity decoder 325p. The negative-polarity buffer 333n functions as a voltage follower for outputting a negative voltage signal (with the common potential Vcom taken as a reference), and each negative-polarity buffer 333n is inputted with the first internal analog signal Aaj (j=2, 4, . . . , m) from the corresponding negative-polarity decoder 325n. For causing the positive-polarity buffer 333p and the negative-polarity buffer 333n to actually operate as the voltage followers, predetermined bias voltages VpB and VnB need to be provided respectively, and these bias voltages VpB, VnB are supplied from the display control circuit 200 as the bias signals BaP1, BaP2, BaN1, BaN2. That is, in the present embodiment, as shown in FIG. 3, the bias voltage VpB is provided as the bias signal BaP1 or BaP2 to the positive-polarity buffer 333p, and the bias voltage VnB is provided as the bias signal BaN1 or BaN2 to the negative-polarity buffer 333n.

In the power-saving mode of the present embodiment, it is configured such that part or all of the positive-polarity buffers 333p and the negative-polarity buffers 333n in the source driver 300 are halted at appropriate timing, and a halt voltage VpOFF is provided as the bias signal BaP1 or BaP2 to the positive-polarity buffer 333p to be halted, while a halt voltage VnOFF is provided as the bias signal BaN1 or BaN2 to the negative-polarity buffer 333n to be halted. The positive-polarity buffer 333p and the negative-polarity buffer, which are respectively provided with the halt voltages VpOFF and VnOFF as the bias signals, stop the operation thereof. An internal current does not flow in the positive-polarity buffer 333p and the negative-polarity buffer, which are halting the operation thereof, and the power consumption is thus reduced greatly. Note that the positive-polarity buffer 333p and the negative-polarity buffer 333n in the present embodiment are configured so as to make output in a high impedance state when the operation is being halted, but they may be configured so as to make output not in the high impedance state.

An output signal of each positive-polarity buffer 333p is outputted as a second internal analog signal Abi (i=1, 3, . . . , m−1), and an output signal of each negative-polarity buffer 333n is outputted as a second internal analog signal Abj (j=2, 4, . . . , m). These second internal analog signals Ab1 to Abm are provided to the output-side connection switching circuit 334. The output-side connection switching circuit 334 is made up of m/2 analog signal connection switches 335, and a kth connection switch 335 is inputted with mutually adjacent second analog signals Ab(2k−1) and Ab(2k) (k=1, 2, . . . , m/2). As shown in FIGS. 3 to 6, in accordance with the mode control signal Cmd and the polarity control signal Cpn, each connection switch 335 switches electrical connection between output ends of a (2k−1)th positive-polarity output buffer 333p and a 2kth negative-polarity output buffer 333n and (2k−1)th and 2kth source lines SL(2k−1), SL(2k), the buffers 333p, 333n respectively outputting the second analog signals Ab(2k−1) and Ab(2k) that are inputted into the connection switch 335 (described in detail later).

The second internal analog signals Ab1 to Abm outputted from the positive-polarity buffer 333p and the negative-polarity buffer 333n are applied as the data signals S1-Sm to the source lines SL1-SLm in the display unit 100 via the connection switching circuit 334 described above.

<1.3 Operation of Source Driver in Normal Mode>

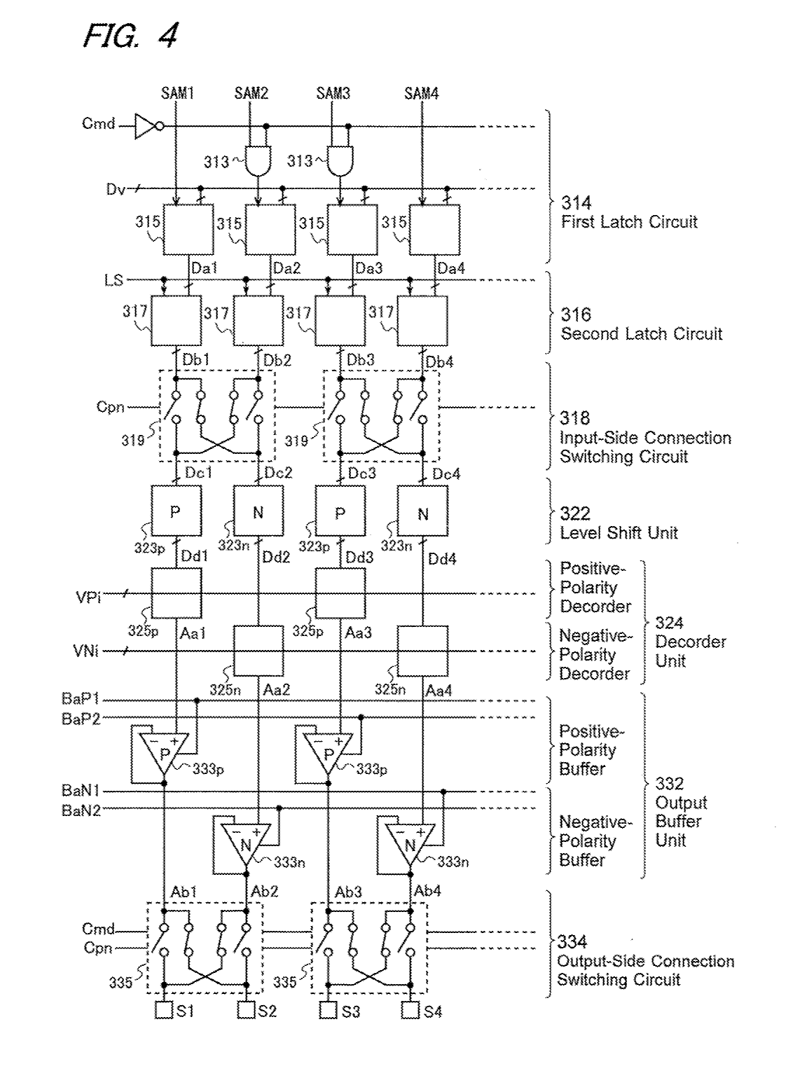

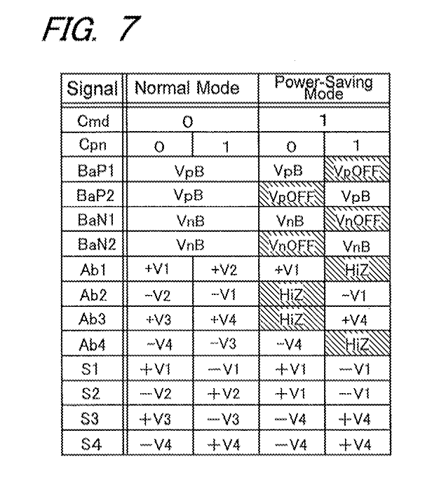

Next, the operation of the source driver 300 in the normal mode is described with reference to FIGS. 3, 4, and 7. FIG. 7 shows values of various signals of the source driver 300 in each operation mode of the present embodiment, and FIGS. 3 and 4 are circuit diagrams specifically showing, in detail, part of the source driver in the normal mode of the present embodiment. The input-side connection switching circuit 318 and the output-side connection switching circuit 334 of FIG. 3 show a connecting state when the polarity control signal Cpn is 0, and the input-side connection switching circuit 318 and the output-side connection switching circuit 334 of FIG. 4 show a connecting state when the polarity control signal Cpn is 1. Note that the mode control signal Cmd is 0 in the normal mode (cf. FIG. 7).

In the normal mode, sampling pulses SAM1 to SAMm sequentially outputted from the shift register 312 are respectively inputted into m latches 315 in the first latch circuit 314 directly or via the AND gate 313, and hence the digital image signals DA for one line (for one horizontal period) that are serially inputted in units of pixels are sequentially taken and held into the m latches 315 based on the sampling pulses SAM1 to SAMm. When the digital image signals for one line are held in the first latch circuit 314 in this manner, the latch strobe signal LS becomes active, and the digital image signals DA for one line are thus taken and held into the second latch circuit 316 as the first internal digital signals Da1 to Dam, and are outputted in parallel as second internal digital signals Db1 to Dbm from m latches 317 in the second latch circuit 316. These second internal digital signals Db1 to Dbm pass through the input-side connection switching circuit 318 and are provided to the level shift unit 322.

Here, when the polarity control signal Cpn is assumed to be 0, as shown in FIG. 3, an odd-numbered second internal digital signal Dbi(2i−1) is inputted into a (2i−1)th level shifter 323p, and an even-numbered second internal digital signal Db(2i) is inputted into a 2ith level shifter 323n (i=1, 2, . . . , m/2). Hereinafter, as described above, the second internal digital signals Db1 to Dbm are converted to the first internal analog signals Aa1 to Aam in the decoder unit 324, and pass through the positive-polarity buffer 333p or the negative-polarity buffer 333n in the output buffer unit 332, to be inputted as the second internal analog signals Ab1 to Abm into the output-side connection switching circuit 334.

Further, when the polarity control signal Cpn is assumed to be 0, as shown in FIG. 3, an odd-numbered second internal analog signal Ab(2i−1) is applied as a data signal S(2i−1) to a (2i−1)th source line SL(2i−1), and an even-numbered second internal analog signal Ab(2i) is applied as a 2ith data signal S(2i) to a 2ith source line SL(2i) (i=1, 2, . . . , m/2).

As thus described, when the polarity control signal Cpn is 0 in the normal mode (the mode control signal Cmd is 0) (in the case of FIG. 3), in accordance with the digital image signals DA for one line, a positive-polarity data signal S(2i−1) is applied to the odd-numbered source line SL(2i−1), and a negative-polarity data signal S(2i) is applied to the even-numbered source line SL(2i) (i=1, 2, . . . , m/2).

Meanwhile, when the polarity control signal Cpn is 1 in the normal mode, the input-side connection switching circuit 318 and the output-side connection switching circuit 334 are in connecting states as shown in FIG. 4. In this case, operation of portions other than the input-side connection switching circuit 318 and the output-side connection switching circuit 334 in the source driver 300 is similar to the operation described above in the case of the polarity control signal Cpn being 0 in the normal mode, namely, the case of FIG. 3, and hence the operation concerning the input-side connection switching circuit 318 and the output-side connection switching circuit 334 is mainly described below.

When the polarity control signal Cpn is 1 in the normal mode, as shown in FIG. 4, each connection switch 319 in the input-side connection switching circuit 318 takes signals, obtained by switching mutually adjacent second internal digital signals Dbj, Db(j+1), as third internal digital signals Dcj, Dc(j+1) (j=1, 3, . . . , m−1). Accordingly, the input-side connection switching circuit 318 outputs the odd-numbered second internal digital signal Db(2i−1) as an even-numbered third internal digital signal Dc(2i), and outputs the even-numbered second internal digital signal Db(2i) as an odd-numbered third internal digital signal Dc(2i−1) (i=1, 2, . . . , m/2).

Further, in this case, each connection switch 335 in the output-side connection switching circuit 334 takes signals obtained by switching mutually adjacent second internal analog signals Abj, Ab(j+1) as data signals Sj, S(j+1) (j=1, 3, . . . , m−1). Accordingly, the output-side connection switching circuit 334 outputs the odd-numbered second internal analog signal Ab(2i−1) as the even-numbered data signal S(2i), and outputs the even-numbered second internal analog signal Ab(2i) as the odd-numbered data signal S(2i−1) (i=1, 2, . . . , m/2).

By the operation of the input-side connection switching circuit 318 and the output-side connection switching circuit 334 as thus described, when the polarity control signal Cpn is 1 in the normal mode (in the case of FIG. 4), the negative-polarity data signal S(2i−1) is applied to the odd-numbered source line SL(2i−1) and the positive-polarity data signal S(2i) is applied to the even-numbered source line SL(2i) (i=1, 2, . . . , m/2) in accordance with the digital image signals DA for one line. That is, a polarity of a data signal Sk which is applied to each data signal line SLk when the polarity control signal Cpn is 1 is opposite to a polarity of a data signal Sk which is applied to each data signal line SLk when the polarity control signal Cpn is 0 (k=1, 2, . . . , m). Thus, in the normal mode, when the polarity control signal Cpn is switched between 0 and 1, the polarity of the data signal Sk which is applied to each data signal line SLk is reversed (cf. signal values in the normal mode shown in FIG. 7).

As described above, according to the source driver 300 in the present embodiment, in the normal mode, it is possible to apply the data signals Sj, S(j+1) with different polarities to the mutually adjacent source lines SLj, SL(j+1) (j=1, 3, . . . , m−1) by using the positive-polarity buffer 333p and the negative-polarity buffer 333n, without using a buffer (hereinafter referred to as a “bipolar buffer”) as a voltage follower capable of outputting both a positive-polarity signal and a negative-polarity signal. Hence it is possible to perform source-reversal driving and dot-reversal driving with low power consumption as compared with the case of using the bipolar buffer in the output buffer unit. Further, according to the present embodiment, the buffer size is reduced and the chip size of an IC including the source driver 300 is also reduced as compared with the configuration using the bipolar buffer.

<1.4 Operation of Source Driver in Power-Saving Mode>

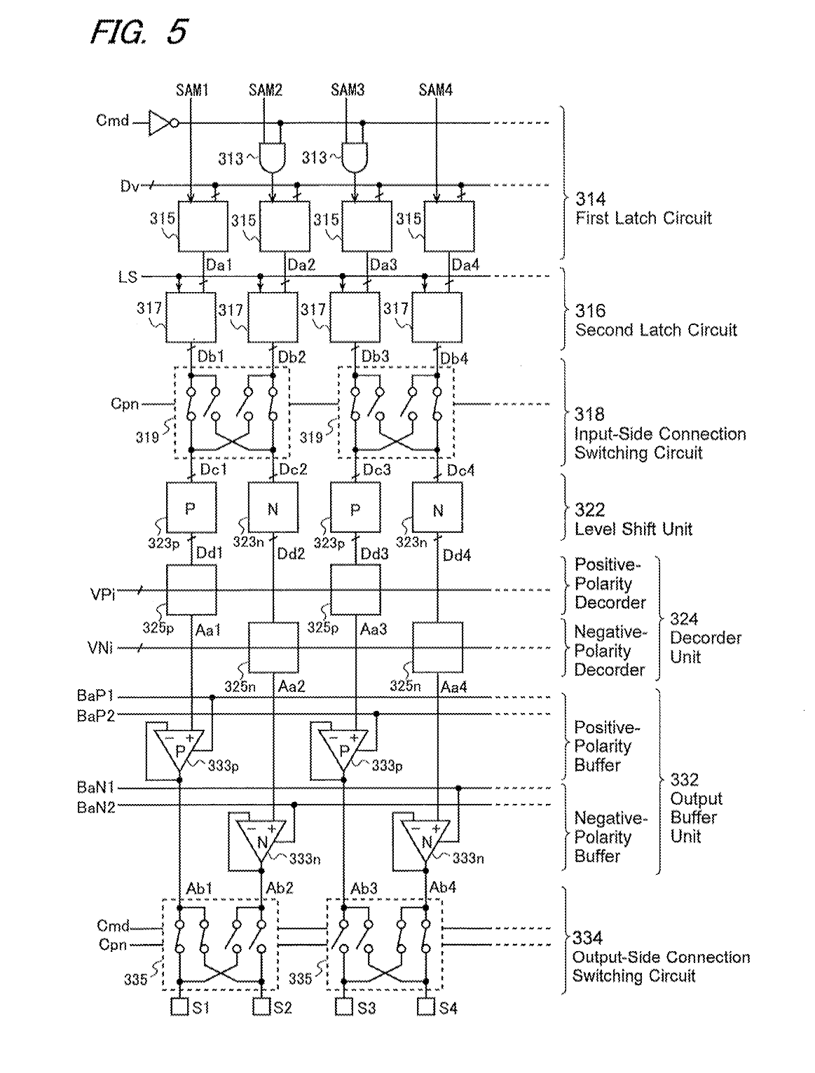

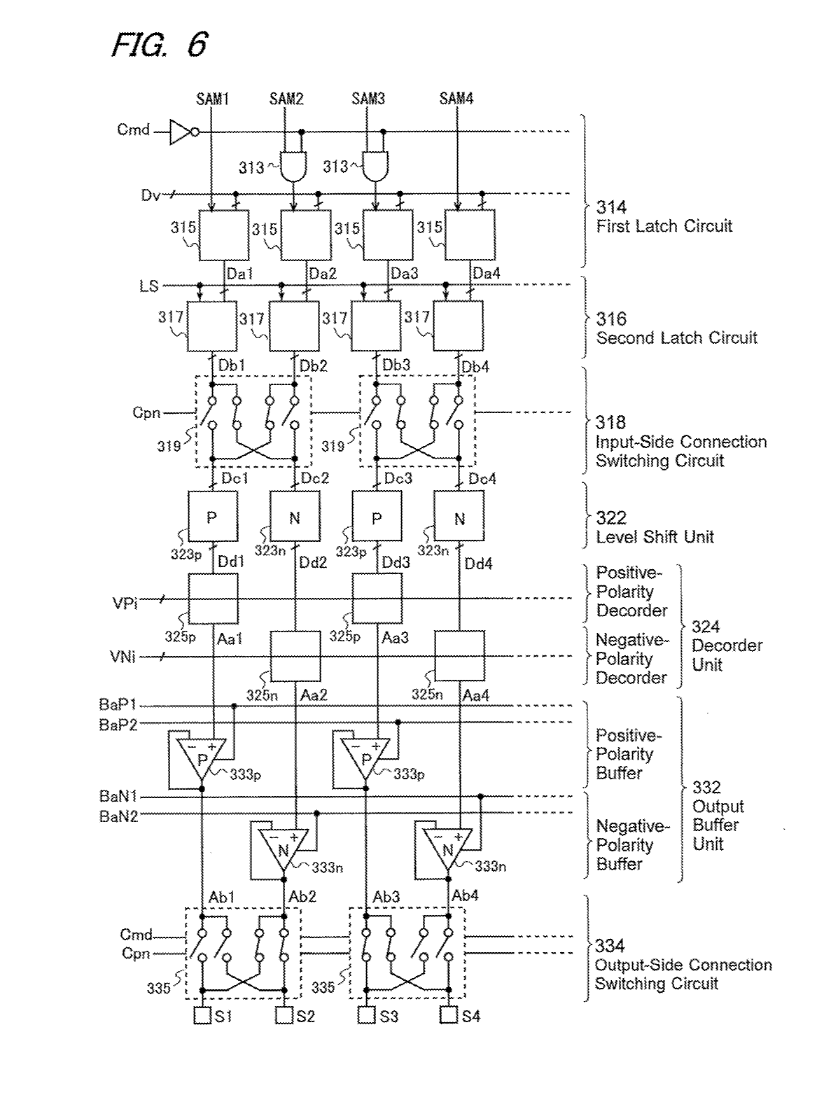

Next, the operation of the source driver 300 in the power-saving mode is described with reference to FIGS. 5, 6, and 7. FIGS. 5 and 6 are circuit diagrams for showing, in detail, part of the source driver in the power-saving mode of the present embodiment. The input-side connection switching circuit 318 and the output-side connection switching circuit 334 of FIG. 5 show connecting states when the polarity control signal Cpn is 0, and the input-side connection switching circuit 318 and the output-side connection switching circuit 334 of FIG. 6 show connecting states when the polarity control signal Cpn is 1. Note that the mode control signal Cmd is 1 in the power-saving mode (cf. FIG. 7).

In the power-saving mode (Cmd=1), among the sampling pulses SAM1 to SAMm that are sequentially outputted from the shift register 312, sampling pulses SAM(4i−3) and SAM(4i) are directly inputted into the corresponding latches 315 in the first latch circuit 314, but inputs of sampling pulses SAM(4i−2) and SAM(4i−1) into the corresponding latches 315 are inhibited by the AND gate 313 (i=1, 2, . . . , m/4). Accordingly, among the digital image signals DA for one line (for one horizontal period) to be inputted serially in units of pixels, signals corresponding to (4i−3)th and 4ith pixels are sequentially taken and held into the corresponding latches 315 based on the sampling pulses SAM(4i−3) and SAM(4i) (i=1, 2, . . . , m/4). When all signals corresponding to the (4i−3)th and 4ith pixels among the digital image signals for one line are held in the first latch circuit 314, the latch strobe signal LS becomes active, and the signals corresponding to the (4i−3)th and 4ith pixels are thus taken and held as first internal digital signals Da(4i−3) and Da(4i) into the second latch circuit 316, and are outputted in parallel as second internal digital signals Db(4i−3) and Db(4i) from the second latch circuit 316. These second internal digital signals Db(4i−3) and Db(4i) pass through the input-side connection switching circuit 318 and are provided to the level shift unit 322.

When the polarity control signal Cpn is assumed to be 0, as shown in FIG. 5, the (4i−3)th second internal digital signal Db(4i−3) is inputted as a third internal digital signal Dc(4i−3) into a (4i−3)th level shifter 323p, and the 4ith second internal digital signal Db(4i) is inputted as a third internal digital signal Dc(4i) into the 4ith level shifter 323n (i=1, 2, . . . , m/4). The (4i−3)th level shifter 323p converts the level of the (4i−3)th third internal digital signal Dc(4i−3) and outputs the converted signal as a fourth internal digital signal Dd(4i−3), and the 4ith level shifter 323n converts the level of the 4ith third internal digital signal Dc(4i) and outputs the converted signal as a fourth internal digital signal Dd(4i). These fourth internal digital signals Dd(4i−3) and Dd(4i) are provided to the decoder unit 324.

In the decoder unit 324, the (4i−3)th fourth internal digital signal Dd(4i−3) is converted to a positive-polarity first internal analog signal Aa(4i−3) by the positive-polarity decoder 325p, and the 4ith fourth internal digital signal Dd(4i) is converted to a negative-polarity first internal analog signal Aa(4i) by the negative-polarity decoder 325n. These first internal analog signals Aa(4i−3) and Aa(4i) are provided to the output buffer unit 332.

When the polarity control signal Cpn is 0 in the power-saving mode (Cmd=1), as shown in FIG. 7, to the output buffer unit 332, the predetermined voltage VpB is provided as a bias signal (hereinafter referred to as a “first bias signal”) BaP1 to the positive-polarity buffer 333p being a (4i−3)th buffer, the halt voltage VpOFF is provided as a bias signal (hereinafter referred to as a “second bias signal”) BaP2 to the positive-polarity buffer 333p being a (4i−1)th buffer, the predetermined bias voltage VnB is provided as a bias signal (hereinafter referred to as a “third bias signal”) BaN1 to the negative-polarity buffer 333n being a 4ith buffer, and the halt voltage VnOFF is provided as a bias signal (hereinafter referred to as a “fourth bias signal”) BaN2 to the negative-polarity buffer 333n being a (4i−2)th buffer.

Accordingly, impedance conversion is performed on the (4i−3)th first internal analog signal Aa(4i−3) by the voltage follower as the positive-polarity buffer 333p, and the converted signal is outputted as a second internal analog signal Ab(4i−3). The impedance conversion is performed on the 4ith first internal analog signal Aa(4i) by the voltage follower as the negative-polarity buffer 333n, and the converted signal is outputted as a second internal analog signal Ab(4i). These second internal analog signals Ab(4i−3) and Ab(4i) are provided to the output-side connection switching circuit 334. Note that the negative-polarity buffer 333n being the (4i−2)th buffer and the positive-polarity buffer 333p being the (4i−1)th buffer halt the operation thereof and currents on the inside thereof are thus suppressed.

In each connection switch 335 in the output-side connection switching circuit 334, when the polarity control signal Cpn is 0 in the power-saving mode, as shown in FIG. 5, the (4i−3)th second internal analog signal Ab(4i−3) is outputted as a (4i−3)th data signal S(4i−3) and a (4i−2)th data signal S(4i−2) (i=1, 2, . . . , m/4). Further, in this case, the 4ith second internal analog signal Ab(4i) is outputted as a (4i−1)th data signal S(4i−1) and a 4ith data signal S(4i).

As thus described, when the polarity control signal Cpn is 0 in the power-saving mode (in the case of FIG. 5), in accordance with the digital image signals DA for one line, the same positive-polarity data signals S(4i−3), S(4i−2) are applied to the (4i−3)th and (4i−2)th source lines SL(4i−3), SL(4i−2), and the same negative-polarity data signals S(4i−1), S(4i) are applied to the (4i−1)th and 4ith source lines SL(4i−1), SL(4i) (i=1, 2, . . . , m/4).

Meanwhile, when the polarity control signal Cpn is 1 in the power-saving mode, the input-side connection switching circuit 318 and the output-side connection switching circuit 334 are in connecting states as shown in FIG. 6. In this case, operation of portions other than the input-side connection switching circuit 318 and the output-side connection switching circuit 334 in the source driver 300 is similar to the operation described above in the case of the polarity control signal Cpn being 0 in the power-saving mode, namely, the case of FIG. 5, and hence the operation concerning each of the input-side connection switching circuit 318 and the output-side connection switching circuit 334 is mainly described below.

When the polarity control signal Cpn is 1 in the power-saving mode, as shown in FIG. 6, each connection switch 319 in the input-side connection switching circuit 318 takes signals, obtained by switching mutually adjacent second internal digital signals Dbj, Db(j+1), as third internal digital signals Dcj, Dc(j+1) (j=1, 3, . . . , m−1). Accordingly, among the digital image signals DA for one line having been inputted into the source driver 300, a signal corresponding to a (4i−3)th pixel passes through the first and second latch circuits 314, 316 and is outputted as a (4i−2)th third internal digital signal Dc(4i−2) from the input-side connection switching circuit 318, and among the digital image signals DA for one line, a signal corresponding to a 4ith pixel passes through the first and second latch circuits 314, 316 and is outputted as a (4i−1)th third internal digital signal Dc(4i−1) from the input-side connection switching circuit 318 (i=1, 2, . . . , m/4). These fourth internal digital signals Dd(4i−2) and Dd(4i−1) are provided to the decoder unit 324.

In the decoder unit 324, the (4i−2)th fourth internal digital signal Dd(4i−2) is converted to a negative-polarity first internal analog signal Aa(4i−2) by the negative-polarity decoder 325n, and the (4i−1)th fourth internal digital signal Dd(4i−1) is converted to a positive-polarity first internal analog signal Aa(4i−1) by the positive-polarity decoder 325p. These first internal analog signals Aa(4i−2) and Aa(4i−1) are provided to the output buffer unit 332.

When the polarity control signal Cpn is 1 in the power-saving mode, as shown in FIG. 7, the output buffer unit 332 is provided with the halt voltage VpOFF as the first bias signal BaP1, the predetermined bias voltage VpB as the second bias signal BaP2, the halt voltage VnOFF as the third bias signal BaN1, and the predetermined bias voltage VnB as the fourth bias signal BaN2.

Accordingly, the impedance conversion is performed on the (4i−2)th first internal analog signal Aa(4i−2) by the voltage follower as the negative-polarity buffer 333n, and the converted signal is outputted as a second internal analog signal Ab(4i−2). Further, the impedance conversion is performed on the (4i−1)th first internal analog signal Aa(4i−1) by the voltage follower as the positive-polarity buffer 333p, and the converted signal is outputted as a second internal analog signal Ab(4i−1). These second internal analog signals Ab(4i−2) and Ab(4i−1) are provided to the output-side connection switching circuit 334. Note that the positive-polarity buffer 333p being the (4i−3)th buffer and the negative-polarity buffer 333n being the 4ith buffer halt the operation thereof and currents on the inside thereof are thus suppressed.

In each connection switch 335 in the output-side connection switching circuit 334, when the polarity control signal Cpn is 1 in the power-saving mode, the (4i−2)th second internal analog signal Ab(4i−2) is outputted as a (4i−3)th data signal S(4i−3) and a (4i−2)th data signal S(4i−2) (i=1, 2, . . . , m/4), as shown in FIG. 6. Further, the (4i−1)th second internal analog signal Ab(4i−1) is outputted as a (4i−1)th data signal S(4i−1) and a 4ith data signal S(4i).

As thus described, when the polarity control signal Cpn is 1 in the power-saving mode (in the case of FIG. 6), in accordance with the digital image signals DA for one line, the same negative-polarity data signals S(4i−3), S(4i−2) are applied to the (4i−3)th and (4i−2)th source lines SL(4i−3), SL(4i−2), and the same positive-polarity data signals S(4i−1), S(4i) are applied to the (4i−1)th and 4ith source lines SL(4i−1), SL(4i) (i=1, 2, . . . , m/4). Accordingly, the polarity of the data signal Sk which is applied to each data signal line SLk when the polarity control signal Cpn is 1 is opposite to the polarity of the data signal Sk which is applied to each data signal line SLk when the polarity control signal Cpn is 0 (k=1, 2, . . . , m). Thus, also in the power-saving mode, when the polarity control signal Cpn is switched between 0 and 1, the polarity of the data signal Sk, which is applied to each data signal line SLk, is reversed (cf. signal values in the power-saving mode shown in FIG. 7).

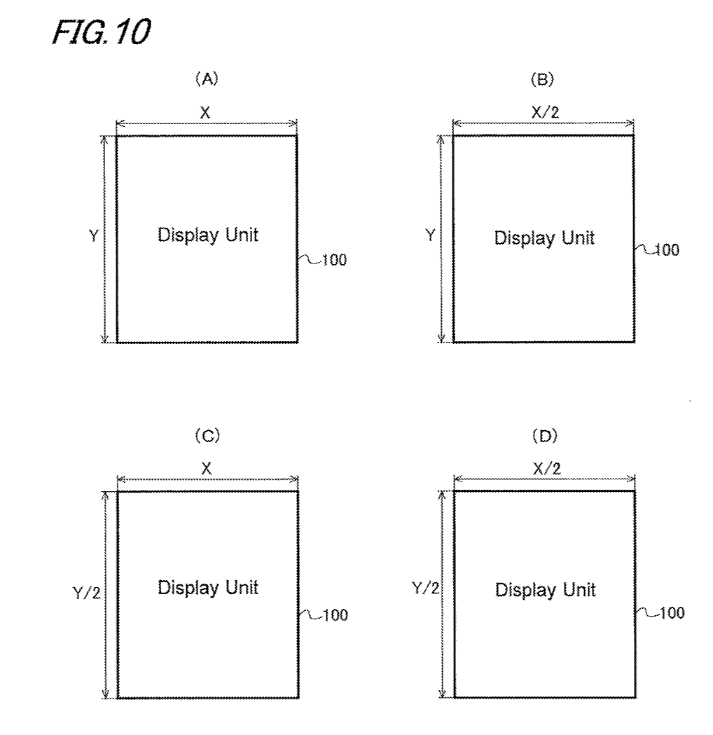

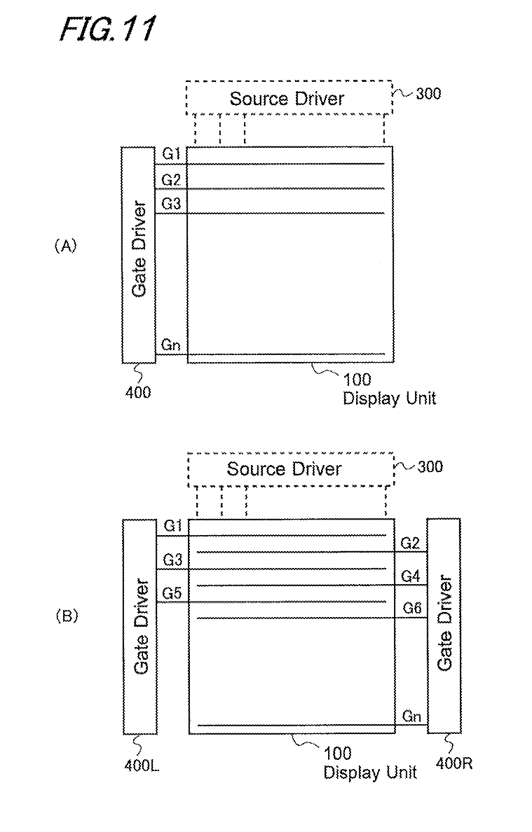

As described above, according to the source driver 300 in the present embodiment, in the power-saving mode, it is possible to apply the data signals with different polarities to every two source lines by using the positive-polarity buffer 333p and the negative-polarity buffer 333n, without using the bipolar buffer. Further, in this power-saving mode, when the polarity control signal Cpn is 0, the (4i−2)th and (4i−1)th buffers 333n, 333p come into the halted state, and when the polarity control signal Cpn is 1, the (4i−3)th and 4ith buffers 333p, 333n come into the halted state. Hence in the power-saving mode as shown in FIG. 10(B), although the horizontal resolution (in the extending direction of the gate line) becomes half of that in the normal mode (FIG. 10(A)), half of the buffers 333p, 333n included in the source driver 300 come into the halted state, thereby making it possible to greatly reduce the power consumption as compared with the normal mode.

<1.5 Effects>

According to the present embodiment as described above, it is possible to perform the dot-reversal driving or the source-reversal driving without using the bipolar buffer in the output buffer unit 332 of the source driver 300, and thereby to favorably display an image while keeping the power consumption low. Further, the present embodiment has the power-saving mode in addition to the normal mode, and in the power-saving mode, although the horizontal resolution decreases, the half of the buffers 333p, 333n included in the source driver 300 come into the halted state, thereby making it possible to greatly reduce the power consumption as compared with the normal mode. In recent years, while resolution of the matrix display device, such as the liquid crystal display device, is increasingly improved, reduction in power consumption is strongly required when such a display device is used in a mobile device. Accordingly, having the power-saving mode capable of greatly reducing the power consumption even though the resolution decreases as in the present embodiment is a great advantage over the conventional display device.

### 2. Second Embodiment

<2.1 Comparative Example>

In the first embodiment, in the power-saving mode, the source lines SL1 to SLm are driven by the source driver 300 in the manner different from that of the normal mode to reduce the power consumption. In contrast, a liquid crystal display device according to a second embodiment of the present invention described below is configured such that in the power-saving mode, the gate lines GL1 to GLn are driven by the gate driver 400 in the manner different from that of the normal mode to reduce the power consumption.

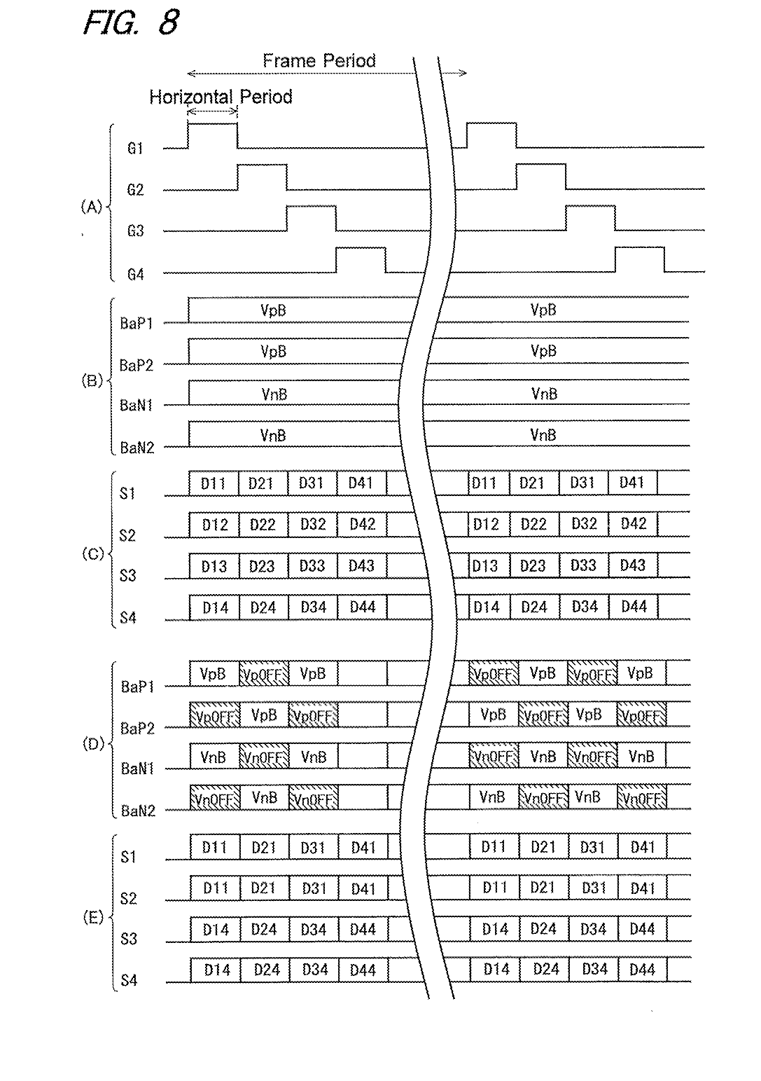

FIGS. 8(A) to 8(E) are timing charts showing operation in the normal mode and the power-saving mode of the liquid crystal display device according to the first embodiment as a comparative example with this second embodiment. Prior to description of the liquid crystal display device according to the second embodiment, this comparative example is first described with reference to FIGS. 8(A) to 8(E).

As shown in FIG. 8(A), in the liquid crystal display device according to the first embodiment, the scanning signals G1 to Gn are sequentially made active (shifted to a high level (H level)) in each one horizontal period in each frame period, to selectively drive the gate lines GL1 to GLn. Further, in the normal mode of the first embodiment, as shown in FIG. 8(B), the predetermined bias voltages VpB are continuously provided as the first and second bias signals BaP1, BaP2, and the predetermined bias voltages VnB are continuously provided as the third and fourth bias signals BaN1, BaN2. Accordingly, all the positive-polarity buffers 333p and the negative-polarity buffers 333n in the source driver 300 continuously operate as the voltage followers. As a result, as shown in FIG. 8(C), the source lines SL1 to SLm are respectively applied with the data signals S1 to Sm showing pixel data Dij (j=1, 2, . . . , m) to be written into the pixel formation portions for one line corresponding to the selected gate line GLi.

Meanwhile, in the power-saving mode of the first embodiment, when the data signal Sj to be applied to each source line SLj is assumed to be reversed in each one horizontal period, as shown in FIG. 8(D), the predetermined bias voltages VpB, VnB are respectively provided as the first and third bias signals BaP1, BaN1 in an odd-numbered horizontal period in a certain frame period (e.g., an odd-numbered frame period). Accordingly, the (4k−3)th positive-polarity buffer 333p and the 4kth negative-polarity buffer 333n operate as the voltage followers (k=1, 2, . . . , m/4), and as shown in FIG. 8(E), a positive-polarity signal showing the pixel data Di(4k−3) among the pixel data Dij (j=1, 2, . . . , m) to be written into the pixel formation portions for one line corresponding to the selected gate line GLi is used as the data signals S(4k−3), S(4k−2), which are respectively applied to the source lines SL(4k−3), SL(4k−2), and a negative-polarity signal showing the pixel data Di(4k) is used as the data signals S(4k−1), S(4k), which are respectively applied to the source lines SL(4k−1), SL(4k) (cf. output-side connection switching circuit 334 in FIG. 5).

In an even-numbered horizontal period in the certain frame period, the predetermined bias voltages VpB, VnB are respectively provided as the second and fourth bias signals BaP2, BaN2. Accordingly, the (4k−2)th negative-polarity buffer 333n and the (4k−1)th positive-polarity buffer 333p operate as the voltage followers (k=1, 2, . . . , m/4), and as shown in FIG. 8(E), a negative-polarity signal showing the pixel data D(i+1)(4k−3) among the pixel data D(i+1)j (j=1, 2, . . . , m) to be written into the pixel formation portions for one line corresponding to the selected gate line GL(i+1) is used as the data signals S(4k−3), S(4k−2), which are respectively applied to the source lines SL(4k−3), SL(4k−2), and a positive-polarity signal showing the pixel data D(i+1)(4k) is used as the data signals S(4k−1), S(4k), which are respectively applied to the source lines SL(4k−1), SL(4k) (cf. the input-side connection switching circuit 318 and the output-side connection switching circuit 334 in FIG. 6).

As shown in FIG. 8(D), in the odd-numbered horizontal period in the certain frame period, the halt voltages VpOFF, VnOFF are respectively provided as the second and fourth bias signals BaP2, BaN2, and hence the negative-polarity buffer 333n being the (4k−2)th buffer and the positive-polarity buffer 333p being the (4k−1)th buffer halt the operation thereof. Further, in the even-numbered horizontal period in the certain frame period, the halt voltages VpOFF, VnOFF are respectively provided as the first and third bias signals BaP1, BaN1, and hence the positive-polarity buffer 333p being the (4k−3)th buffer and the negative-polarity buffer 333n being the 4kth buffer halt the operation thereof. In this manner, in the power-saving mode, half of the buffers in the source driver 300 is brought into the halted state to greatly reduce the power consumption as compared with the normal mode.

Note that the operation of the liquid crystal display device in the frame period subsequent to the certain frame period (e.g., the even-numbered frame period) is substantially the same as the operation in the certain frame period except that the polarity of the data signal to be applied to the source line is different in the corresponding horizontal period and that the buffer in the operating state and the buffer in the halted state are switched (cf. FIGS. 8(A) to 8(E)).

<2.2 Configuration and Operation of Second Embodiment>

In the power-saving mode, the liquid crystal display device according to the second embodiment of the present invention is different from the first embodiment in the timing for changes in the scanning signals G1 to Gn outputted from the gate driver and the polarity control signal Cpn and the first to fourth bias signals BaP1, BaP2, BaN1, BaN2 provided from the display control circuit to the source driver, but is substantially similar to the liquid crystal display device according to the first embodiment in the other respects. Hence in the following, the same portion in the configuration of the present embodiment as that of the first embodiment is provided with the same reference numeral, and the detailed description thereof is omitted (cf. FIGS. 1 to 7). Further, the operation in the normal mode in the present embodiment is similar to that in the first embodiment. Accordingly, the operation of the power-saving mode is mainly described in the following.

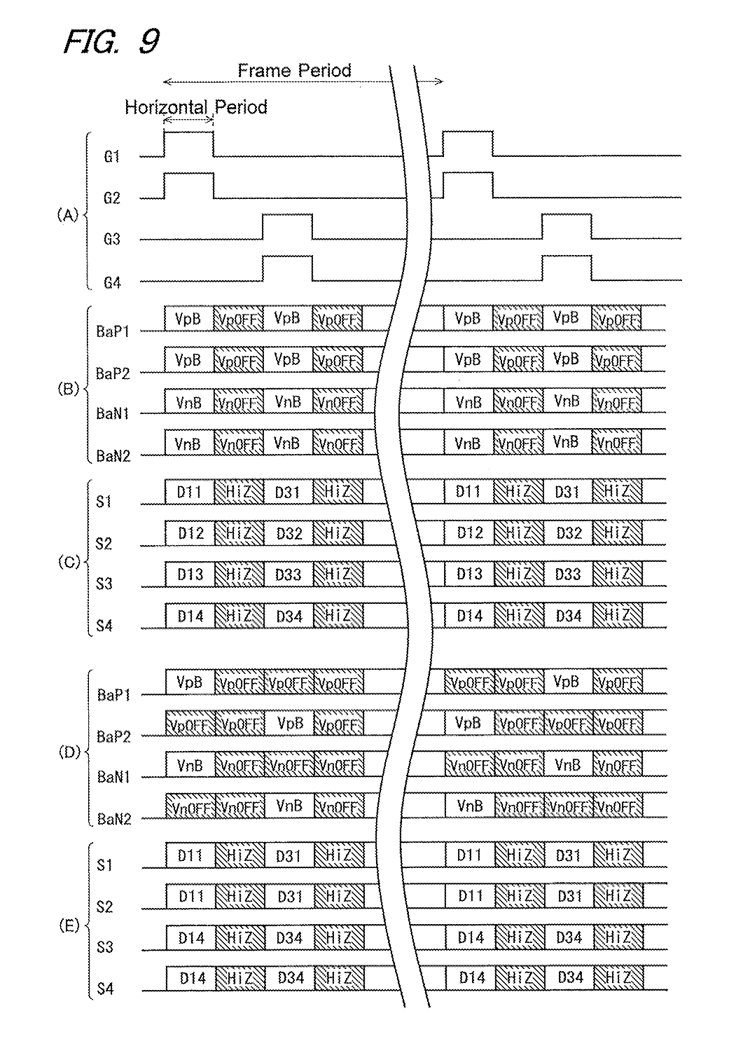

The gate driver 400 in the present embodiment is configured such that in the power-saving mode, the gate lines GL1 to GLn are sequentially selected with two mutually adjacent gate lines GL(2i−1), GL(2i) taken as a unit. However, after a lapse of one horizontal period from completion of selection of the two gate lines GL(2i−1), GL(2i), the next two gate lines GL(2i+1), GL(2i+2) start to be selected, and in that one horizontal period, all the gate lines GL1 to GLn are in a non-selected state (i=1, 2, . . . , (n−2)/2). That is, in the power-saving mode of the present embodiment, as shown in FIG. 9(A), the gate driver 400 generates the scanning signals G1 to Gn such that two mutually adjacent scanning signals G(2i−1), G(2i) simultaneously become active (the H level) in only one horizontal period in each frame period, and all the scanning signals G1 to Gn become non-active (the L level) in the next one horizontal period.

FIG. 9(B) is a timing chart showing voltages that are provided to the source driver 300 as the first to fourth bias signals BaP1, BaP2, BaN1, BaN2 in a first operation example in the power-saving mode of the present embodiment.

In this operation example, in the odd-numbered horizontal period in each frame period, the predetermined bias voltages VpB are provided as the first and second bias signals BaP1, BaP2, and the predetermined bias voltages VnB are provided as the third and fourth bias signals BaN1, BaN2. That is, in this horizontal period, bias voltages similar to those in the normal mode are provided to the source driver 300. When this horizontal period is assumed to be a (2i−1)th horizontal period (i=1, 2, . . . , m/2), in this horizontal period, the source lines SL1 to SLm are respectively applied with the data signals S1 to Sm showing pixel data D(2i−1)j (j=1, 2, . . . , m) to be written into the pixel formation portions for one line corresponding to the (2i−1)th gate line GL(2i−1). Further, in this horizontal period, with the (2i−1)th and 2ith gate lines GL(2i−1), GL(2i) selected, the pixel data D(2i−1)j (j=1, 2, . . . , m) are written into not only the pixel formation portions for one line corresponding to the (2i−1)th gate line, but also the pixel formation portions for one line corresponding to the 2ith gate line GL(2i).

In the even-numbered horizontal period in each frame period, the halt voltages VpOFF are provided as the first and second bias signals BaP1, BaP2, and the halt voltages VnOFF are provided as the third and fourth bias signals BaN1, BaN2, respectively. Accordingly, all the positive-polarity buffers 333p and the negative-polarity buffers 333n in the source driver 300 come into the halted state. Note that the positive-polarity buffer 333p and the negative-polarity buffer 333n in the present embodiment are configured so as to make output in the high impedance state when the operation is being halted, but they may be configured so as to make output not in the high impedance state.

In the present operation example as thus described, since the two mutually adjacent gate lines GL(2i−1), GL(2i) are simultaneously selected (FIG. 9(A)), as shown in FIG. 10(C), the vertical resolution (in the extending direction of the source line) is reduced to half of that in the normal mode (FIG. 10(A)). However, since all the buffers 333p and the buffers 333n in the source driver 300 come into the halted state in the half period in each frame (each even-numbered horizontal period), the power consumption is reduced greatly as compared with the normal mode.

Since the reversal drive system is adopted in the liquid crystal display device, in two adjacent frame periods, polarities of data signals, which are applied to the source lines, are different in the corresponding horizontal periods. However, except for this point, the operation in each of the two frame periods is substantially the same (cf. FIG. 9(C)).

FIG. 9(D) is a timing chart showing voltages that are provided to the source driver 300 as the first to fourth bias signals BaP1, BaP2, BaN1, BaN2 in a second operation example in the power-saving mode of the present embodiment.

In this operation example, in the odd-numbered horizontal period in a certain frame period (e.g., odd-numbered frame period), the predetermined bias voltage VpB is provided as the first bias signal BaP1 while the predetermined bias voltage VnB is provided as the third bias signal BaN1, and the halt voltage VpOFF is provided as the second bias signal BaP2 while the halt voltage VnOFF is provided as the fourth bias signal BaN2. That is, in this horizontal period, a bias voltage similar to that in the power-saving mode of the first embodiment is provided to the source driver 300. When this horizontal period is assumed to be the (2i−1)th horizontal period (i=1, 2, . . . , m/2), a positive-polarity signal showing the pixel data D(2i−1)(4k−3) among the pixel data D(2i−1)j (j=1, 2, . . . , m) to be written into the pixel formation portions for one line corresponding to the (2i−1)th gate line GL(2i−1) is used as the data signals S(4k−3), S(4k−2), which are respectively applied to the source lines SL(4k−3), SL(4k−2), and a negative-polarity signal showing the pixel data D(2i−1)(4k) is used as the data signals S(4k−1), S(4k), which are respectively applied to the source lines SL(4k−1), SL(4k) (k=1, 2, . . . , m/4) (cf. the output-side connection switching circuit 334 in FIG. 5). Further, in this horizontal period, with the (2i−1)th and 2ith gate lines GL(2i−1), GL(2i) selected, the pixel data D(2i−1)(4k−3) and the pixel D(2i−1)(4k) (k=1, 2, . . . , m/4) are written into not only the pixel formation portions for one line corresponding to the (2i−1)th and 2ith gate lines GL(2i−1), but also the pixel formation portions for one line corresponding to the 2ith gate line GL(2i).

In the even-numbered horizontal period in the certain frame period, the halt voltage VpOFF is provided as the first and second bias signals BaP1, BaP2, and the halt voltage VnOFF is provided as the third and fourth bias signals BaN1, BaN2, whereby all the positive-polarity buffers 333p and the negative-polarity buffers 333n in the source driver 300 come into the halted state.

In the present operation example as thus described, since the data signals with the same signal values are applied to the two mutually adjacent source lines (FIG. 9(E)) and the two mutually adjacent gate lines are selected simultaneously (FIG. 9(A)), the horizontal resolution and the vertical resolution are reduced to half of those in the normal mode (FIG. 10(A)) as shown in FIG. 10(D). However, in addition to that all the buffers 333p, 333n in the source driver 300 come into the halted state in the half period in each frame period (each even-numbered horizontal period), also in each odd-numbered horizontal period, the half of the buffers 333p, 333n included in the source driver 300 come into the halted state, and hence the power consumption can be reduced more than in the first operation example.

Note that the operation of the liquid crystal display device in the frame period subsequent to the certain frame period (e.g. the even-numbered frame period) is substantially the same as the operation in the certain frame period except that the polarity of the data signal to be applied to the source line is different in the corresponding horizontal period and that the buffer in the operating state and the buffer in the halted state are switched in the odd-numbered horizontal period (cf. FIGS. 9(D)(E)).

Further, other than the configuration in which the gate driver 400 in the present embodiment is disposed on one side of the display unit 100 (one of the left and the right in the figure) as shown in FIG. 11(A), the gate driver 400 may be configured by first and second gate drivers 400L, 400R respectively disposed on one side and the other side of the display unit 100 (the left and the right in the figure) as shown in FIG. 11(B). In the former configuration, the scanning signals G1 to Gn for driving the gate lines GL1 to GLn in the display unit 100 are outputted from one gate driver 400, whereas in the latter configuration, for example, the scanning signals G1, G3, G5, . . . for driving the odd-numbered gate lines GL1, GL3, GL5, . . . in the display unit 100 are outputted from the first gate driver 400L, and the scanning signals G2, G4, G6, . . . for driving the even-numbered gate lines GL2, GL4, GL6, . . . are outputted from the second gate driver 400R.

<2.3 Effects>

The present embodiment as described above has the power-saving mode in addition to the normal mode, and in the power-saving mode, although the vertical resolution decreases, all the buffers 333p, 333n in the source driver 300 come into the halted state (FIG. 9(B), FIG. 9(D)) in the half period of each frame period, thereby making it possible to greatly reduce the power consumption as compared with the normal mode. Moreover, in the second operation example in the present embodiment, the half of the buffers 333p, 333n in the source driver 300 come into the halted state also in the odd-numbered horizontal period in which the buffers 333p, 333n are operating in the source driver 300 (FIG. 9(D)), thereby making it possible to further reduce the power consumption.

### 3. Variant

<3.1 First Variant>Although the half of the positive-polarity buffer 333p and the negative-polarity buffer 333n included in the source driver 300 come into the halted state in the power-saving mode in the first embodiment, it can be considered that the operation of the circuit related to generation of signals to be inputted into the buffers 333p, 333n in the halted state are also halted to further reduce the power consumption of the source driver 300.

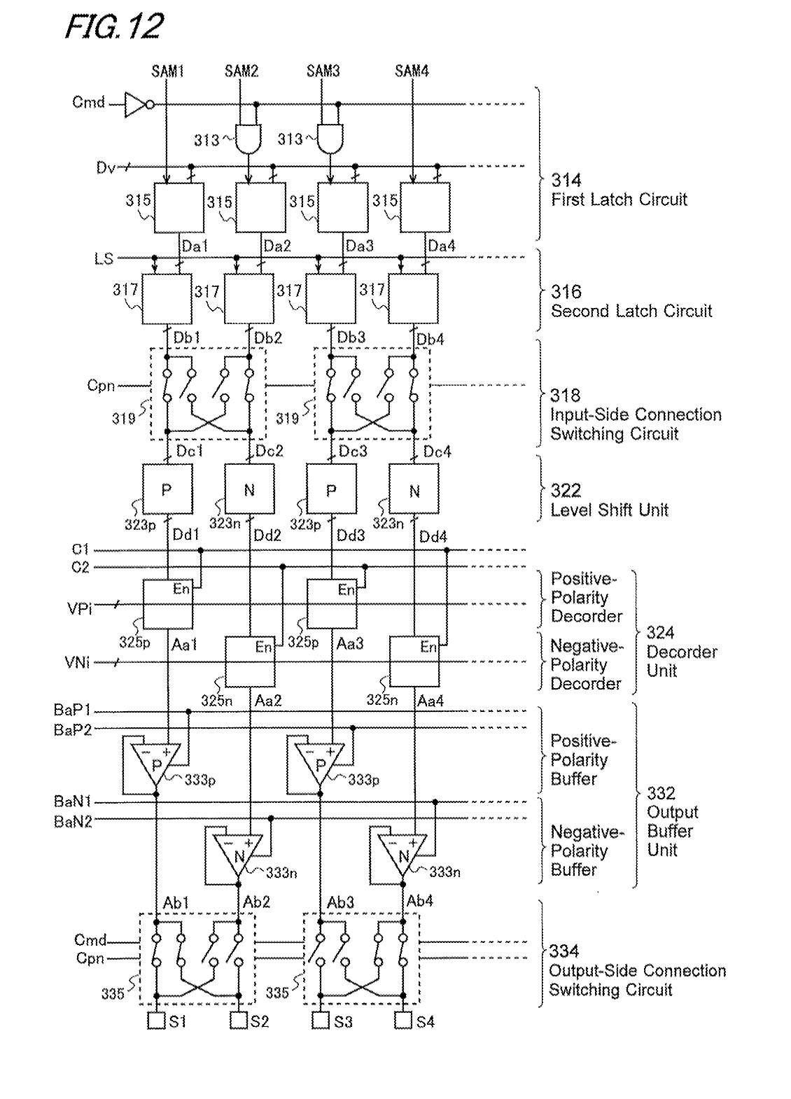

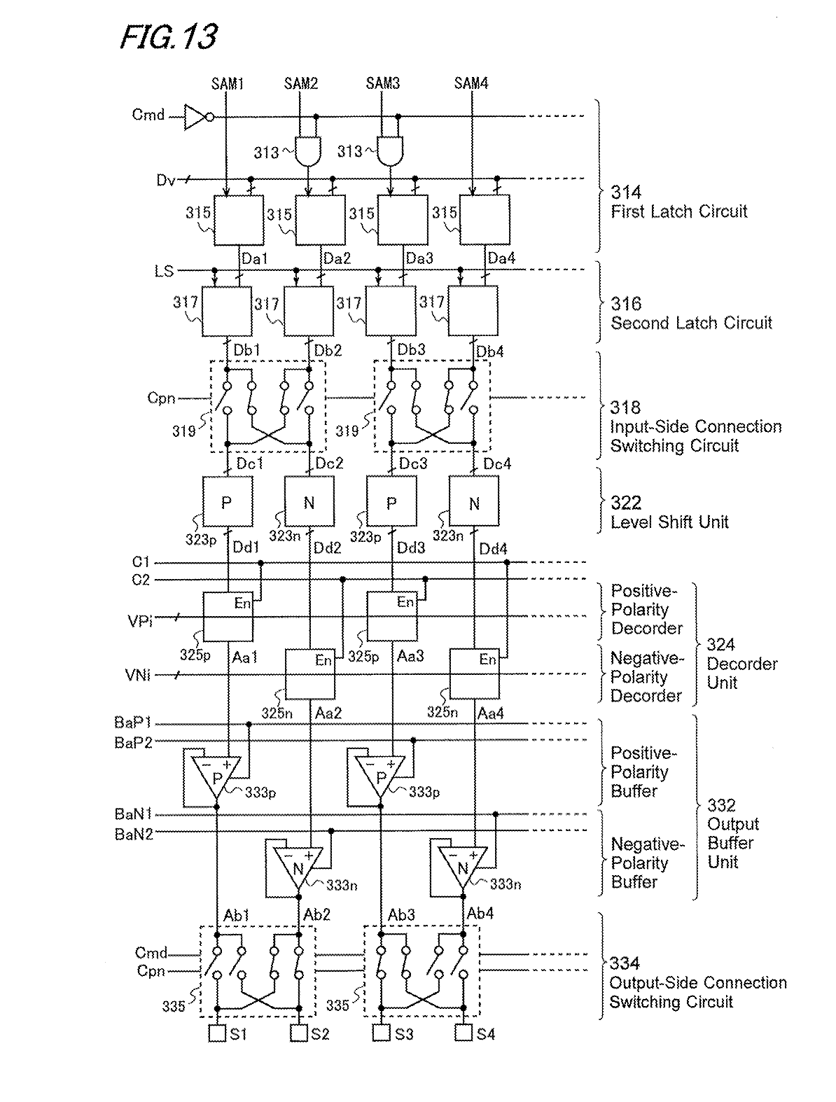

FIGS. 12 and 13 are circuit diagrams for describing a first variant as an example obtained by modifying the first embodiment from the viewpoint as thus described. FIG. 12 shows in detail a configuration of part of the source driver 300 in the present variant when the polarity control signal Cnp is 0 in the power-saving mode, and FIG. 13 shows in detail a configuration of part of the source driver 300 in the present variant when the polarity control signal Cnp is 1 in the power-saving mode. In the present variant, each of the positive-polarity and negative-polarity decoders 325p, 325n has an enable terminal En, and each of the decoders 325p, 325n performs normal operation when “1” is inputted in the enable terminal En, but comes into the halted state when “0” is inputted in the enable terminal En. Further, in the present variant, a first enable signal C1 and a second enable signal C2 are generated in the display control circuit 200 as control signals for controlling the operation and halt of each of the decoders 325p, 325n, and provided to the source driver 300. As shown in FIGS. 12 and 13, the first enable signal C 1 is inputted into the enable terminals En of the positive-polarity decoder 325p being the (4i−3)th decoder and the negative-polarity decoder 325n being the 4ith decoder, and the second enable signal C2 is inputted into the enable terminals En of the negative-polarity decoder 325n being the (4i−2)th decoder and the positive-polarity decoder 325p being the (4i−1)th decoder (i=1, 2, . . . , m/4).

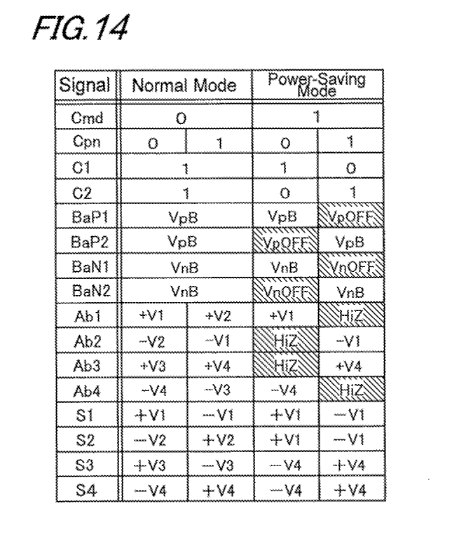

FIG. 14 is a diagram showing values of various signals of the source driver 300 in the respective operation modes of the present variant. As shown in FIG. 14, in the normal mode, the first and second enable signals C1, C2 are both “1”, whereas in the power-saving mode, C1=1 and C2=0 when the polarity control signal Cpn is 0, and C1=0 and C2=1 when the polarity control signal Cpn is 1. As seen from the comparison among FIGS. 12, 13, and 14, “0” is provided as the first or second enable signal C1 or C2 to the enable terminals En of the positive-polarity or negative-polarity decoders 325p or 325n for generating a signal to be inputted into the positive-polarity or negative-polarity buffer 333p or 333n which is provided with the halt voltage VpOFF or VnOFF. Therefore, the source driver 300 in the present variant is controlled by the first and second enable signals C1, C2 such that decoders 325p, 326n for generating signals to be inputted into the buffers 333p, 333n in the halted state are halted.

Alternatively, in addition to the decoders 325p, 326n for generating signals to be inputted into the buffers 333p, 333n in the halted state, the source driver 300 may be controlled so as to stop operation of other circuits (e.g., the latches 315, 317 corresponding to the first and second latch circuits 314, 316) related to generation of the signals to be inputted. The AND gate 313 in the first latch circuit 314 is a constituent for this control.

Although the present variant has the configuration for further reducing the power consumption as described above, attention is focused on that the power consumption in the output buffer unit 332 is particularly large as compared with those in the other circuits, and the circuit for controlling the operation and halt in the power-saving mode may thus be limited to the output buffer unit 332 (the positive-polarity and negative-polarity buffers 333p, 333n) from the viewpoint of simplifying the configuration of the source driver 300.

<3.2 Second Variant>

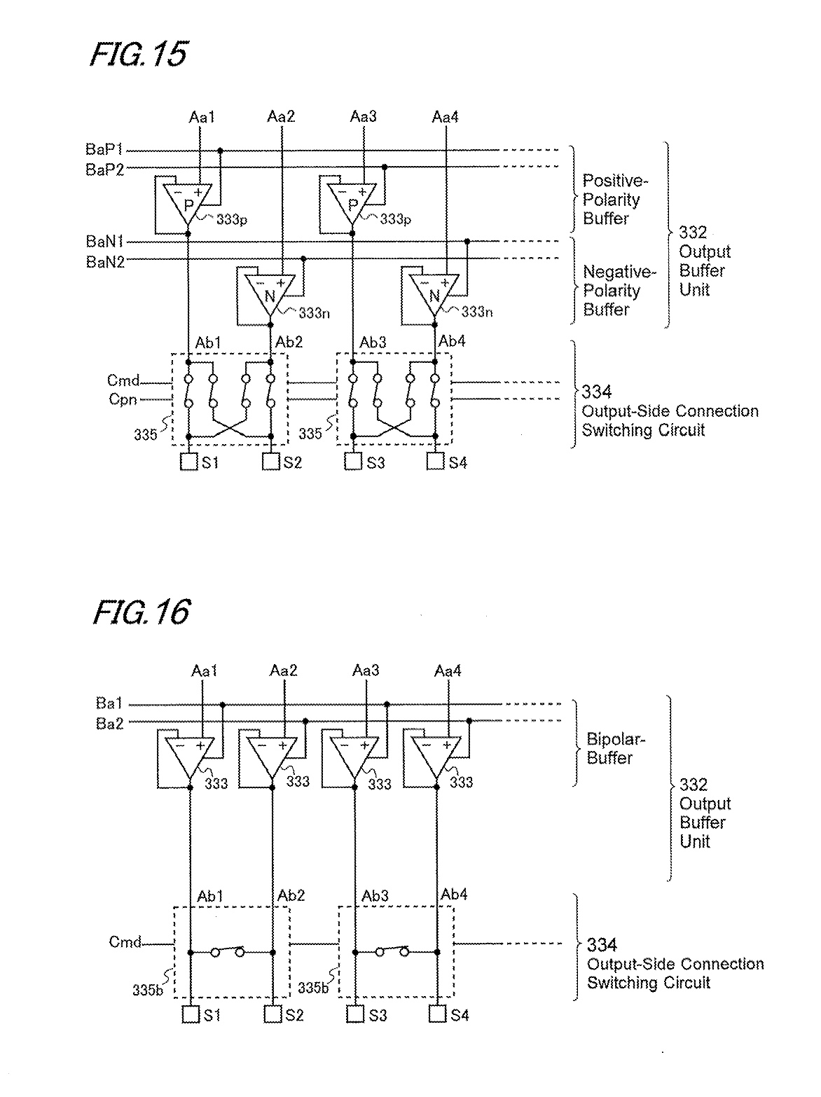

FIG. 15 is a circuit diagram for describing a second variant of the first embodiment. As described above, the positive-polarity buffer 333p and the negative-polarity buffer 333n included in the source driver 300 in the first embodiment come into the halted state when being provided with the halt voltages VpOFF, VnOFF as bias signals. Assuming that these positive-polarity buffer 333p and the negative-polarity buffer 333n are configured so as to make output in the high impedance state when being in the halted state, in the power-saving mode of the first embodiment, the positive-polarity buffer 333p and the negative-polarity buffer 333n which are connected to the respective connection switches 335 in the output-side connection switching circuit 334 come into a high impedance state, reciprocally (cf. FIGS. 7, 5, 6, etc.). Accordingly, in place of the connecting states shown in FIGS. 5 and 6, the connecting state of each connection switch 335 in the power-saving mode may be set to a connecting state shown in FIG. 15, namely, a state where the output ends of the positive-polarity buffer 333p and the negative-polarity buffer 333n which are connected to the respective connection switches 335 are connected to both of two corresponding source lines. According to the present variant as thus described, the switching operation in the output-side connection switching circuit 334 (connection switch 335) is unnecessary in the power-saving mode.

<3.3 Third Variant>

Next, a third variant of the first embodiment is described.

Although the output buffer unit 332 in the source driver 300 of the first embodiment includes the two types of buffers that are the positive-polarity buffer 333p and the negative-polarity buffer 333n, the output buffer unit 332 may be configured to include only a bipolar buffer 333 in place of those buffers. In this case, m first internal analog signals Aa1 to Aam outputted from the decoder unit 324 are respectively inputted into m bipolar buffers 333, and the second internal analog signals Ab1 to Abm are outputted from these m bipolar buffers 333. Each connection switch 335 in the output-side connection switching circuit 334 is inputted with two each of these second internal analog signals Ab1 to Abm. That is, the ith connection switch 335 is inputted with the mutually adjacent second analog signals Ab(2i−1), Ab(2i) (i=1, 2, . . . , m/2). The configuration of each connection switch 335 in the present variant can be made similar to the configuration of the first embodiment (cf. FIGS. 3 to 7).

In cases where each bipolar buffer 333 is configured so as to make output in the high impedance state when being in the halted state due to provision of the halt voltage VpOFF as the bias signals Ba1, Ba2, a connection switch 335b with a configuration shown in FIG. 16 may be used in place of the connection switch 335 with the configuration shown in FIGS. 3 to 6. This connection switch 335b is controlled only by the mode control signal Cmd irrespective of the polarity control signal Cpn, and when the mode control signal Cmd is 0, namely, in the normal mode, the connection switch 335b comes into a connecting state where the second internal analog signals Ab(2i−1), Ab(2i) are directly outputted as the data signals S(2i−1), S(2i) and applied to the source lines SL(2i−1), SL(2i), and when the mode control signal Cmd is 1, namely, in the power-saving mode, the connection switch 335b comes into a state where the output ends of two bipolar buffers 333 connected to the connection switch 335b are connected to both of the two source lines SL(2i−1), SL(2i) (a connecting state where the output ends of two bipolar buffers 333 are short-circuited). In the power-saving mode of the present variant, two bipolar buffers 333 connected to each connection switch 335b are provided with the bias signals Ba1, Ba2 so as to make output in a high impedance state, reciprocally.

Also in the present variant as thus described, the source lines SL1 to SLm can be driven in a similar manner to the first embodiment. As a result, similarly to the first embodiment, the horizontal resolution decreases in the power-saving mode, but the half of the buffers 333 included in the source driver 300 come into the halted state, thereby making it possible to greatly reduce the power consumption as compared with the normal mode.

<3.4 Fourth Variant>

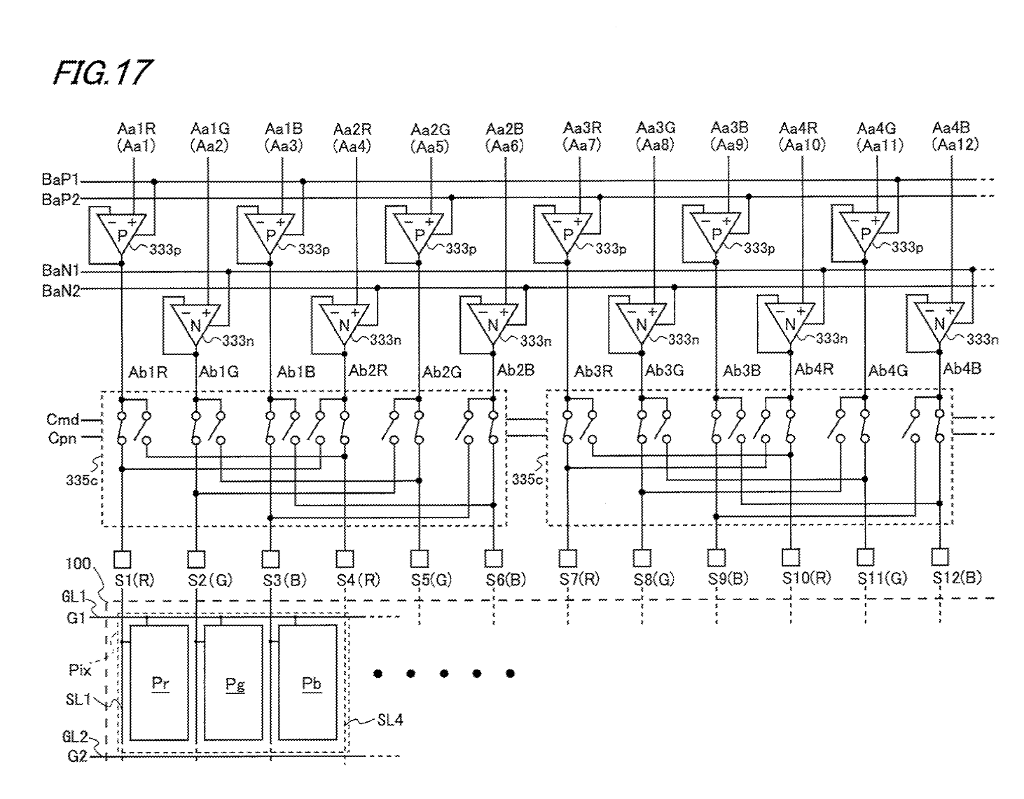

In the matrix display device, in order to display a color image based on three or more predetermined primary colors, there are often cases where each pixel in the display image is made up of the number of sub-pixels equal to the number of primary colors, and in accordance with this, each pixel formation portion is made up of the number of sub-pixel formation portions equal to the number of primary colors. In this case, each sub-pixel formation portion corresponds to one of the data signal lines SL1 to SLm, and corresponds to one of the scanning signal lines GL1 to GLn. Hereinafter, in order to display a color image based on three primary colors of red (R), green (G), and blue (B), an active matrix-type liquid crystal display device with each pixel formation portion Pix, made up of an R sub-pixel formation portion Pr, a G sub-pixel formation portion Pg, and a B sub-pixel formation portion Pb, is described as a fourth variant (cf. FIG. 17 described later). Note that each of the R sub-pixel formation portion Pr, the G sub-pixel formation portion Pg, and the B sub-pixel formation portion Pb in the present variant is assumed to correspond to the pixel formation portion Pix in the first embodiment and have a similar configuration to that of the pixel formation portion (cf. FIG. 1)

FIGS. 17 to 21 are views for describing the present variant. In the first embodiment, each connection switch 335 in the output-side connection switching circuit 334 is configured so as to switch the connection between the two mutually adjacent source lines SL(2i−1), SL(2i) and the output ends of the positive-polarity buffer 333p and the negative-polarity buffer 333n corresponding to those source lines (i=1, 2, . . . , m/2), but as shown in FIG. 17, etc., in the present variant, each connection switch 335c in the output-side connection switching circuit 334 includes the following: a portion configured to switch the connection between two mutually adjacent source lines (hereinafter referred to as “R adjacent source lines”) SL(6i−5), SL(6i−2) among source lines that are applied with data signals showing the R sub-pixels and the output ends of the positive-polarity buffer 333p and the negative-polarity buffer 333n corresponding to those source lines; a portion configured to switch the connection between two mutually adjacent source lines (hereinafter referred to as “G adjacent source lines”) SL(6i−4), SL(6i−1) among source lines that are applied with data signals showing the G sub-pixels and the output ends of the negative-polarity buffer 333n and the positive-polarity buffer 333p corresponding to those source lines; and a portion configured to switch the connection between two mutually adjacent source lines (hereinafter referred to as “B adjacent source lines”) SL(6i−3), SL(6i) among source lines that are applied with data signals showing the B sub-pixels and the output ends of the positive-polarity buffer 333p and the negative-polarity buffer 333n corresponding to those source lines (i=1, 2, . . . , m/6). FIGS. 17 to 20 show only the configuration of each connection switch 335c and the configuration of the output buffer unit in the output-side connection switching circuit 334. Configurations other than these and the above-described configuration concerning the pixel formation portion Pix are substantially similar to those in the first embodiment, and hence the same portion is provided with the same reference numeral and the detailed description thereof is omitted. However, in the present variant, the input-side connection switching circuit 318 also includes a connection switch for performing switching operation similar to that of the connection switch 335c in the output-side connection switching circuit 334.

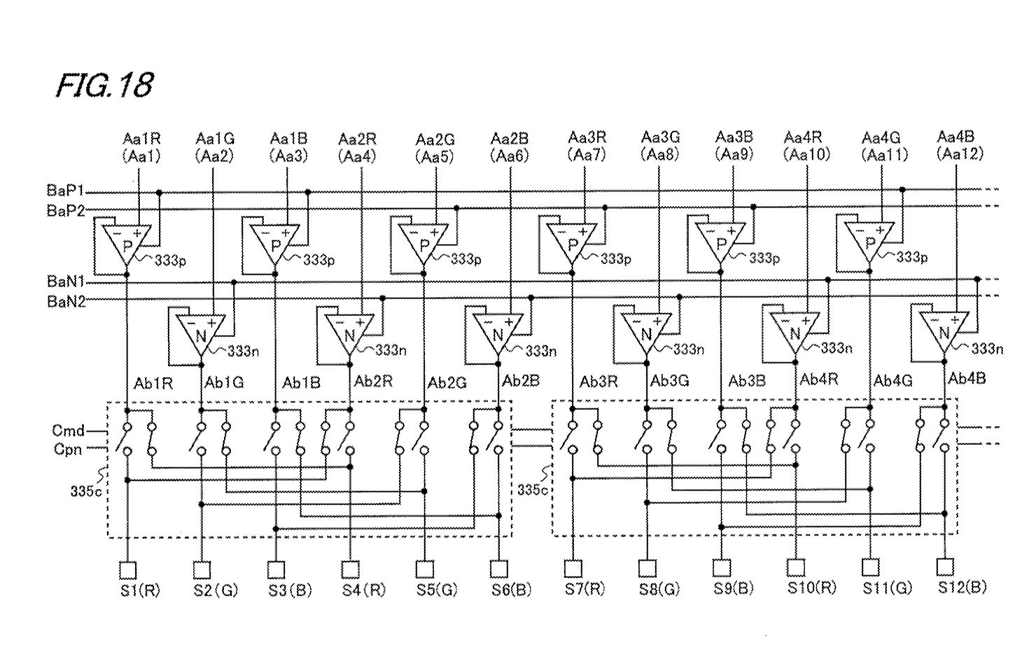

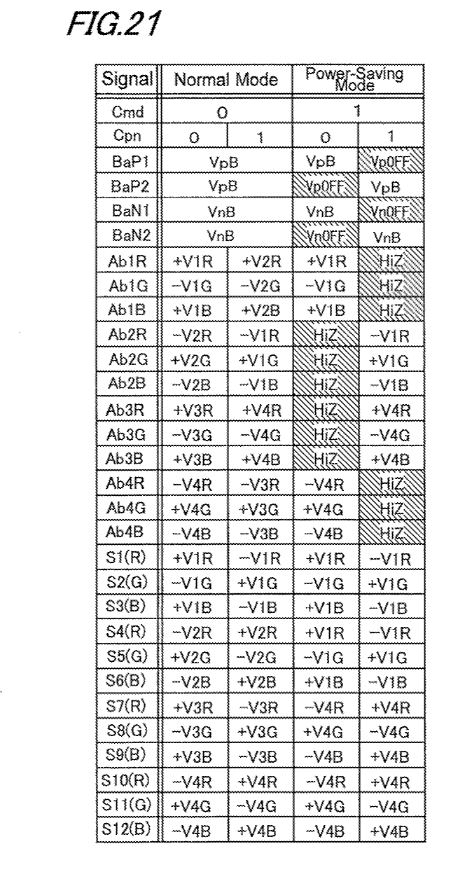

In the normal mode of the present variant, the first to fourth bias signals BaP1, BaP2, BaN1, BaN2 as shown in FIG. 21 are provided in accordance with the polarity control signal Cpn in a similar manner to the first embodiment (FIG. 7), and each connection switch 335c comes into a connecting state as shown in FIG. 17 when the polarity control signal Cpn is 0, and comes into a connecting state as shown in FIG. 18 when the polarity control signal Cpn is 1. Hence in the normal mode, the second internal analog signals Ab1R, Ab1G, Ab1B, . . . that are output signals of the output buffers 333p, 333n and the data signals S1, S2, S3, . . . are values as shown in FIG. 21. Note that in FIGS. 17 to 21, “Si(X)” represents that the ith data signal Si shows (a value of) an X sub-pixel (X=R, G, B). Further, in FIG. 21, “ViX” or “−ViX” shows a voltage to be applied to the (3i−2)th, (3i−1)th or 3ith source line as follows: when X=R, it is a voltage (data signal value) showing an R sub-pixel to be applied to the (3i−2)th source line; when X=G, it is a voltage showing a G sub-pixel to be applied to the (3i−1)th source line; and when X=B, it is a voltage showing a B sub-pixel to be applied to the 3ith source line. Note that “HiZ” shows that the output buffers 333p, 333n make output in the high impedance state.

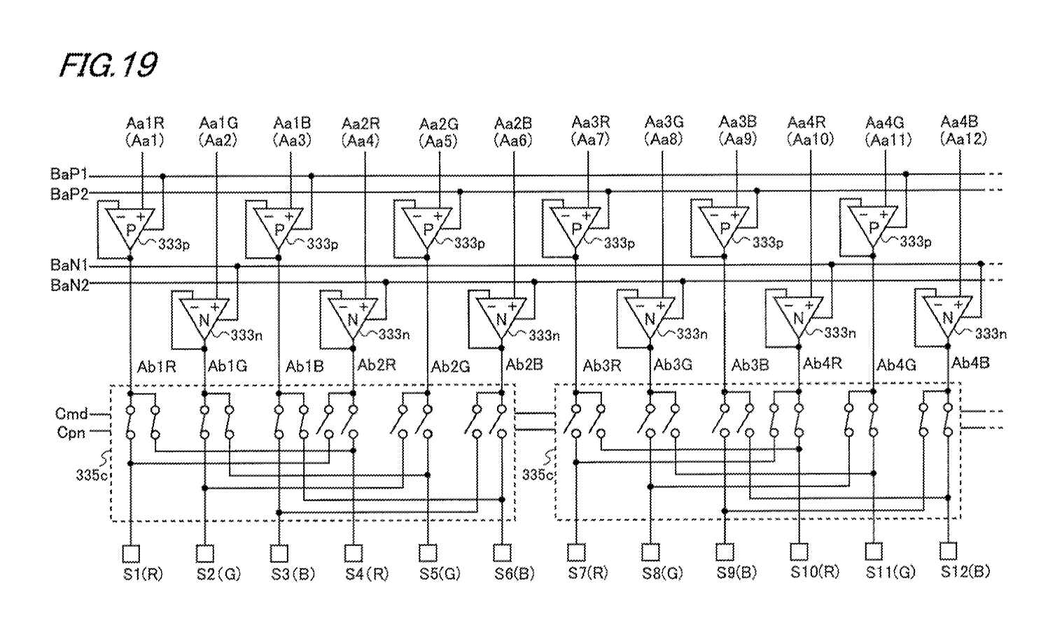

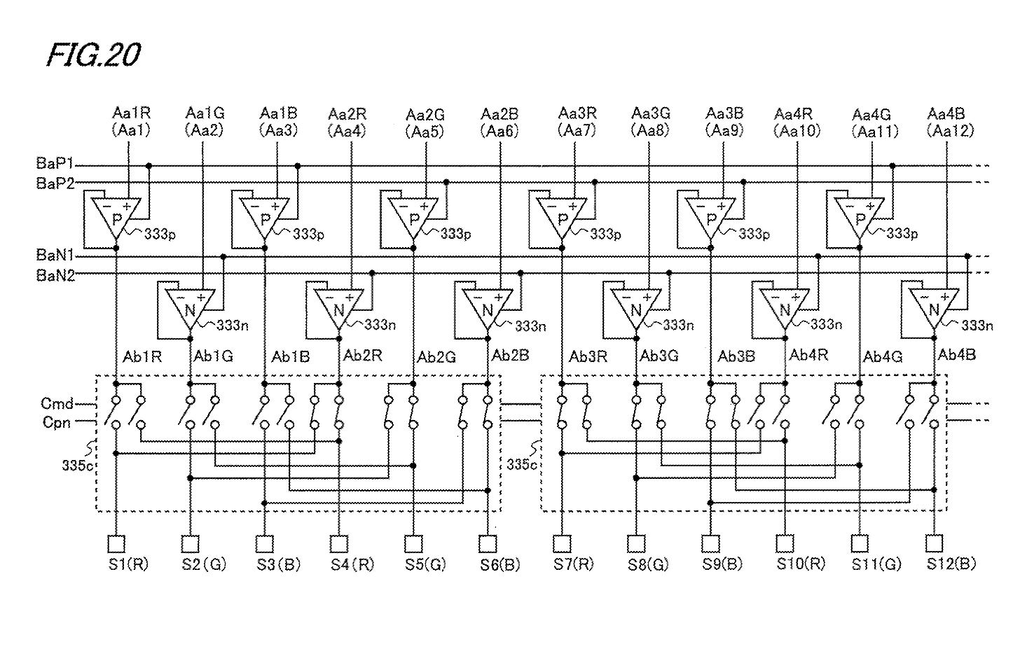

Also in the power-saving mode of the present variant, the first to fourth bias signals BaP1, BaP2, BaN1, BaN2 as shown in FIG. 21 are provided in accordance with the polarity control signal Cpn in a similar manner to the first embodiment (FIG. 7), and each connection switch 335c comes into a connecting state as shown in FIG. 19 when the polarity control signal Cpn is 0, and comes into a connecting state as shown in FIG. 20 when the polarity control signal Cpn is 1. Hence in the power-saving mode, the second internal analog signals Ab1R, Ab1G, Ab1B, . . . that are output signals of the output buffers 333p, 333n, and the data signals S1, S2, S3, . . . are values as shown in FIG. 21.

As seen from FIG. 21, the present variant with the pixel formation portion Pix made up of the R sub-pixel Pr formation, the G sub-pixel formation portion Pg, and the B sub-pixel formation portion Pb for displaying a color image also exerts a similar effect to that of the first embodiment and in the power-saving mode, although the horizontal resolution decreases, the half of the buffers 333p, 333n included in the source driver 300 come into the halted state, thereby making it possible to greatly reduce the power consumption as compared with the normal mode.

<3.5 Fifth Variant>

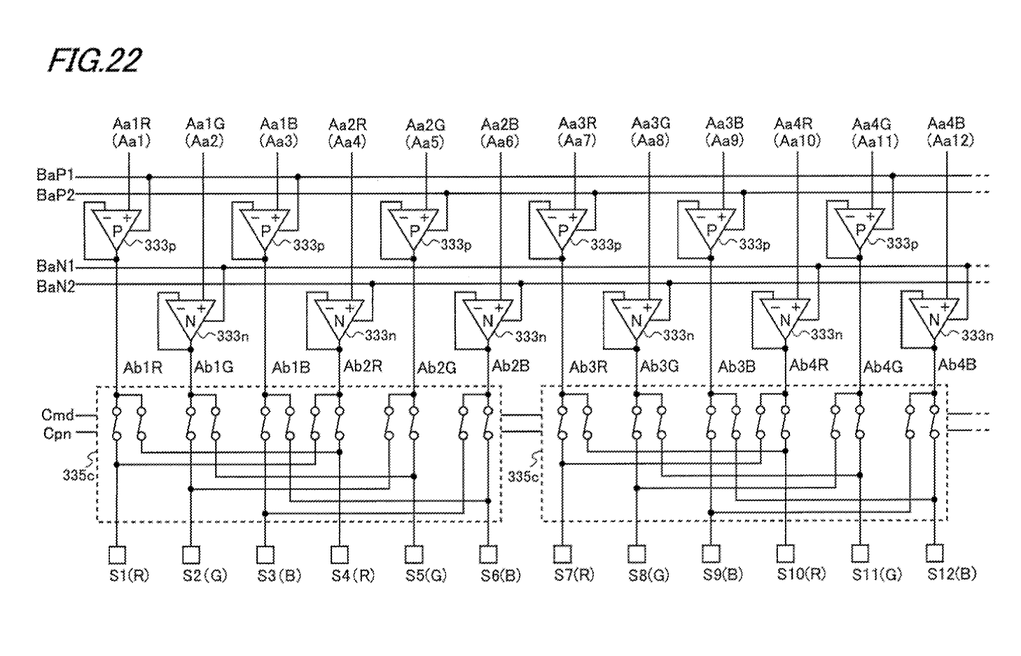

FIG. 22 is a circuit diagram for describing a fifth variant as an example obtained by further modifying the fourth variant. Assuming that the positive-polarity buffer 333p and the negative-polarity buffer 333n included in the source driver 300 are configured so as to make output in the high impedance state when being in the halted state, in the power-saving mode of the fourth variant, among the positive-polarity buffer 333p and the negative-polarity buffer 333n connected to each connection switch 335c in the output-side connection switching circuit 334, the positive-polarity buffer 333p and the negative-polarity buffer 333n that respectively output the second internal analog signals Ab(2i−1)X, Ab(2i)X showing the sub-pixels of the same color come into a high impedance state, reciprocally (i=1, 2, . . . , m/3; X=R, G, B) (cf. FIG. 21). Accordingly, in place of the connecting states shown in FIGS. 19 and 20, the connecting state of each connection switch 335c in the power-saving mode may be set to a connecting state shown in FIG. 22, namely, a state where, among the positive-polarity and negative-polarity buffers 333p, 333n connected to each connection switch 335c in the output-side connection switching circuit 334, the output ends of the positive-polarity and negative-polarity buffers 333p, 333n which respectively output the second internal analog signals Ab(2i−1)X, Ab(2i)X showing the sub-pixels of the same color, are connected to both of two corresponding source lines. According to the present variant as thus described, the switching operation in the output-side connection switch 335c is unnecessary in the power-saving mode.

<3.6 Sixth Variant>

The fifth variant is configured such that the source lines respectively connected to the R sub-pixel formation portion Pr, the G sub-pixel formation portion Pg, and the B sub-pixel formation Pb are simultaneously driven to display a color image, but alternatively, the present invention is also applicable to the case of applying a so-called SSD (Source Shared Drive) system in which three source lines corresponding to the three primary colors R, G, B are taken as one set. That is, the present invention is also applicable to a configuration in which the source lines in the display unit 100 are grouped by taking, as one set, an R source line connected with the R sub-pixel formation portion Pr, a G source line connected with the G sub-pixel formation portion Pg, and a B source line connected with the B sub-pixel formation Pb (more generally, taking the number of source lines which is equal to the number of primary colors for color image display as one set), and the three source lines in each set are driven in a time-division manner. Hereinafter, the example of applying the present invention to this configuration is described as a sixth variant of the first embodiment. Note that in the following, in the display unit 100, m source lines (m/3 sets of source line groups) are assumed to be arranged such that the R source line, the G source line, and the B source line repeatedly appear in this order.

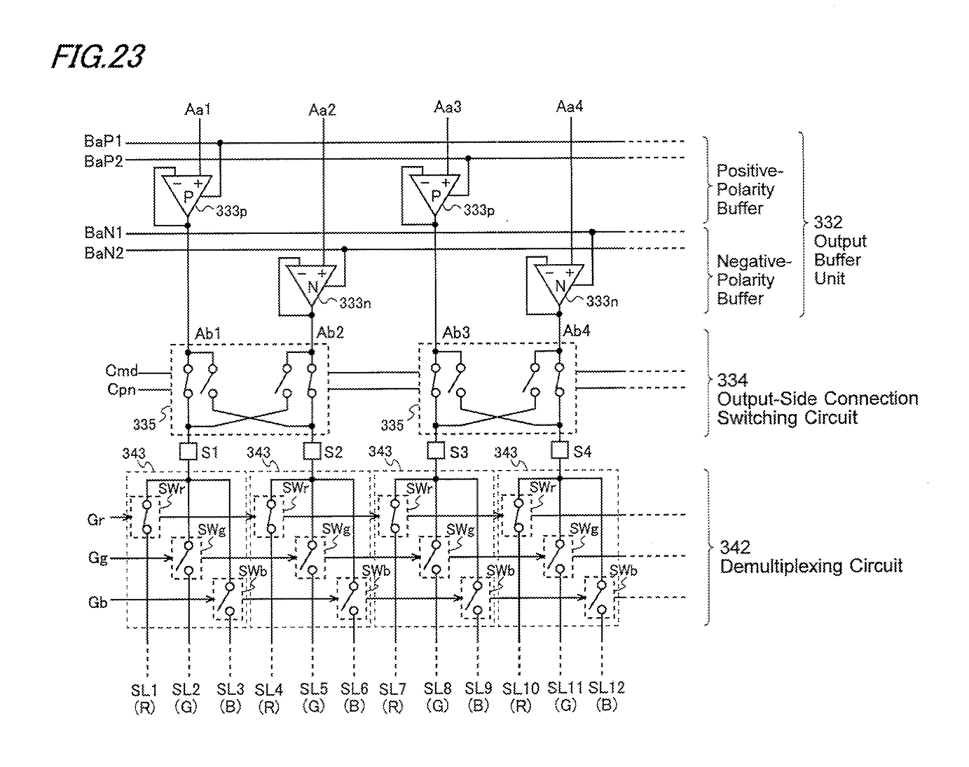

FIG. 23 is a circuit diagram for describing the present variant, and shows a configuration of a main part of the source driver in the present variant. In the present variant, each frame period is divided into three sub-frame periods including an R sub-frame period, a G sub-frame period, and a B sub-frame period. The source driver is configured as follows: signals which show pixel data to be provided to m/3 R sub-pixel formation portions Pr in the m/3 pixel formation portions Pix corresponding to one display line are outputted as the data signals S1 to S(m/3) in the R sub-frame period; signals which show pixel data to be provided to m/3 G sub-pixel formation portions Pg in the m/3 pixel formation portions Pix are outputted as the data signals S1 to S(m/3) in the G sub-frame period; and signals which show pixel data to be provided to m/3 B sub-pixel formation portions Pb in the m/3 pixel formation portions Pix are outputted as the data signals S1 to S(m/3) in the B sub-frame period.

As shown in FIG. 23, in the present variant, there is provided a demultiplexing circuit 342 made up of m/3 demultiplexers 343 inputted respectively with the above data signals S1 to S(m/3). This demultiplexing circuit 342 may be formed integrally with the display unit 100, or may be provided in the source driver 300 configured separately from the display unit 100. Each demultiplexer 343 includes three switches SWr, SWg, SWb, and one ends of these switches SWr, SWg, SWb are provided with a corresponding data signal Si, while the other ends of these switches SWr, SWg, SWb are respectively connected to the source line SL(3i−2) as the R source line, the source line SL(3i−1) as the G source line, and the source line SL(3i) as the B source line (i=1, 2, . . . , m/3).

In the present variant, in the display control circuit 200, an R control signal Gr, a G control signal Gg, and a B control signal Gb are generated to respectively control the on and off of the switches SWr, SWg, SWb in the demultiplexer 343, and provided to the demultiplexing circuit 342. Each X control signal Gx (X=R, G, B; x=r, g, b) is at the high-level (H level) during the X sub-frame period in each frame period and at the low level (L level) during the other periods. Each switch SWx in each demultiplexer 343 is in an on-state when the X control signal Gx is at the H level and in an off-state when the X control signal Gx is at the L level. Hence each data signal Si is provided to: the source line SL(3i−2) as the R source line in the R sub-frame period; the source line SL(3i−1) as the G source line in the G sub-frame period; and the source line SL(3i) as the B source line in the B sub-frame period (i=1, 2, . . . , m/3). Meanwhile, the gate lines GL1 to GLn in the display unit 100 are selectively driven by the gate driver 400, and the operation of sequentially making the gate lines GL1 to GLn active are repeated with each of the R sub-frame period, the G sub-frame period, and the B sub-frame period set as a cycle. By the drive of the source lines SL1 to SLm and the gate lines GL1 to GLn as thus described, red sub-pixel data is written into the R sub-pixel formation portion Pr in the R sub-frame period, green sub-pixel data is written into the G sub-pixel formation portion Pg in the G sub-frame period, and blue sub-pixel data is written into the B sub-pixel formation portion Pb in the B sub-frame period, to thereby display a color image on the display unit 100.

As described above, in the present variant of displaying a color image by the SSD system, it is possible to achieve the normal mode and the power-saving mode for performing the operation in a substantially similar configuration and in a similar manner to the first embodiment, except for the demultiplexing circuit 342 (cf. FIGS. 3 to 7). In this power-saving mode, although the horizontal resolution decreases, the half of the buffers 333p, 333n included in the source driver 300 come into the halted state, (FIG. 8(D)), thereby making it possible to greatly reduce the power consumption as compared with the normal mode.

In the present variant, the demultiplexing circuit 342 as shown in FIG. 23 is provided in the first embodiment to achieve the color image display based on the SSD system, but the demultiplexing circuit 342 as shown in FIG. 23 can also be provided in the second embodiment to achieve the color image display based on the SSD system. In this case, it is possible to achieve the normal mode and the power-saving mode for performing the operation in a substantially similar configuration and in a similar manner to the second embodiment, except for the demultiplexing circuit 342. In this power-saving mode, although the vertical resolution or the vertical and horizontal resolution decreases, all the buffers 333p and the buffers 333n in the source driver 300 come into the halted state in the half period in each frame (FIG. 9(B)), or in addition to this, the half of the buffers 333p and the buffers 333n in the source driver 300 come into the halted state in periods other than the above period of the halted state (FIG. 9(D)), thereby making it possible to greatly reduce the power consumption as compared with the normal mode.

### 4. Other Embodiments and Variants

When the present invention is to be applied to a liquid crystal display device as in each of the embodiments described above, a liquid crystal panel of any system, such as a liquid crystal panel of a VA (Vertical Alignment) system or a liquid crystal panel of an IPS (In Plane Switching) system, may be used as the display unit 100.

The present invention is not limited to the liquid crystal display device, but is also applicable to other types of display devices such as an organic EL (Electroluminescence) display device as long as it is a matrix display device. That is, a display device is included in the scope of the present invention as long as it is a matrix display device having the power-saving mode in addition to the normal mode, and having, in the power-saving mode, a configuration to halt part of buffers for driving the data signal lines (source lines) by reducing the horizontal resolution as in the first embodiment, and/or a configuration to halt the buffers for driving the data signal lines in part of each frame period by reducing the vertical resolution as in the second embodiment. Hence the display device according to the present invention is not limited to the display device of the AC drive system such as the liquid crystal display device, or is not limited to the display device of a voltage control system (or it may be the display device of a current control system). The buffer in the source driver 300 is not limited to the source amplifier that functions as the voltage follower as described above, and the present invention is applicable to a buffer or an amplifier as long as it outputs a data signal (typically an analog voltage signal or an analog current signal) showing a voltage or a current to be provided to the data signal line.

In each of the embodiments and variants thereof described above, the horizontal resolution is halved to halt the half (1/2) of the output buffers 333p, 333n in the source driver 300, thereby reducing the power consumption, but the present invention is not limited thereto. More generally, the power consumption can be reduced by setting the horizontal resolution to 1/N (N is an integer of 2 or more) to halt (N−1)/N of the output buffers 333p, 333n in the source driver 300 by a technique similar to that in the first embodiment. This also applies to the case of decreasing the vertical resolution to reduce the power consumption, and more generally, the power consumption can be reduced by setting the horizontal resolution to 1/N (N is an integer of 2 or more) to halt the output buffers 333p, 333n in the source driver 300 in a substantially (N−1)/N period in each frame period by a technique similar to that in the second embodiment.

### INDUSTRIAL APPLICABILITY

The present invention is applicable to an active matrix-type display device, a data signal line drive circuit of the same, and a method for driving the same, and is suitable for an active matrix-type liquid crystal display device, for example.

### DESCRIPTION OF REFERENCE CHARACTERS

10: THIN FILM TRANSISTOR (TFT) (SWITCHING ELEMENT)

100: DISPLAY UNIT

200: DISPLAY CONTROL CIRCUIT

300: SOURCE DRIVER (DATA SIGNAL LINE DRIVE CIRCUIT)

310: DATA SHIFT UNIT

320: DA CONVERSION UNIT

324: DECODER UNIT

330: OUTPUT UNIT

332: OUTPUT BUFFER UNIT

333p: POSITIVE-POLARITY BUFFER

333n: NEGATIVE-POLARITY BUFFER

334: OUTPUT-SIDE CONNECTION SWITCHING CIRCUIT

335, 335b, 335c: CONNECTION SWITCH

342: DEMULTIPLEXING CIRCUIT

343: DEMULTIPLEXER

Pix: PIXEL FORMATION PORTION

Pr: R SUB-PIXEL FORMATION PORTION

Pg: G SUB-PIXEL FORMATION PORTION

Pb: B SUB-PIXEL FORMATION PORTION

SL1 to SLm: SOURCE LINE (DATA SIGNAL LINE)

GL1 to GLn: GATE LINE (SCANNING SIGNAL LINE)

S1 to Sm: DATA SIGNAL

G1 to Gn: SCANNING SIGNAL

Cmd: MODE CONTROL SIGNAL

Cpn: POLARITY CONTROL SIGNAL

BaP1, BaP2, BaN1, BaN2: BIAS SIGNAL

1. A data signal line drive circuit of a display device which has at least two operation modes including a normal mode and a power-saving mode, and includes a plurality of data signal lines, a plurality of scanning signal lines that intersect with the plurality of data signal lines, and a plurality of pixel formation portions arranged in a matrix along the plurality of data signal lines and the plurality of scanning signal lines, the data signal line drive circuit comprising:
a data signal generation unit configured to generate a plurality of internal data signals, which show voltages or currents to be applied to the plurality of data signal lines, based on an externally inputted image signal; and
an output buffer unit including a plurality of buffers that are provided so as to correspond to the plurality of data signal lines and configured to output the plurality of internal data signals as a plurality of data signals to be applied to the plurality of data signal lines,
wherein the output buffer unit is configured such that
in the normal mode, the plurality of buffers output the plurality of data signals to be applied to the plurality of data signal lines, and
in the power-saving mode, at least part of the plurality of buffers are operated so as to apply the same data signals to two or a greater predetermined number of pixel formation portions that are adjacent in an extending direction of the data signal line or in an extending direction of the scanning signal line, and
among the plurality of buffers, buffers other than buffers outputting data signals to be applied to any of the plurality of data signal lines are halted, or the plurality of buffers are halted in a period in which the plurality of data signals are not applied to the plurality of data signal lines.

2. The data signal line drive circuit according to claim 1, further comprising a connection switching circuit configured to switch connection between the plurality of buffers and the plurality of data signal lines,
wherein the connection switching circuit
connects each of the plurality of buffers to a corresponding data signal line in the normal mode, and
connects each of part of the plurality of buffers to a corresponding data signal line and other one or more data signal lines that are adjacent to the corresponding data signal line or within a predetermined range in the power-saving mode, and
the output buffer unit is configured so as to halt buffers that are not connected to any of the plurality of data signal lines, among the plurality of buffers, in the power-saving mode.

3. The data signal line drive circuit according to claim 2, wherein
the display device is a display device of an AC drive system,
the plurality of buffers are made up of two types of buffers including a positive-polarity buffer that outputs a positive-polarity data signal and a negative-polarity buffer that outputs a negative-polarity data signal,
the connection switching circuit
connects the plurality of buffers to the plurality of data signal lines and switches connection between the plurality of buffers and the plurality of data signal lines in accordance with reversal of polarities of the plurality of data signals to be applied to the plurality of data signal lines such that a polarity of each of the buffers matches a polarity of a data signal to be applied to a data signal line to be connected with the relevant buffer,
connects each of the buffers to one data signal line of a corresponding data signal line and other one data signal line that is adjacent to the corresponding data signal line or within a predetermined range, and switches the data signal line connected with each of the buffers between the corresponding data signal line and the other one data signal line in accordance with reversal of the polarities, in the normal mode, and
connects each of part of the plurality of buffers to a corresponding data signal line and other one or more data signal lines that are adjacent to the corresponding data signal line or within a predetermined range, and switches the buffer connected to each of the data signal lines between the plurality of buffers in accordance with reversal of the polarities, in the power-saving mode, and
the output buffer unit is configured so as to halt buffers that are not connected to any of the plurality of data signal lines, among the plurality of buffers in the power-saving mode.

4. The data signal line drive circuit according to claim 3, wherein
the plurality of buffers are configured such that polarities of two buffers corresponding to two mutually adjacent data signal lines are different from each other,
the connection switching circuit
groups the two mutually adjacent data signal lines as one set,
connects one of the two buffers corresponding to two data signal lines of each set to one of the two data signal lines, while connecting the other of the two buffers to the other of the two data signal lines, and switches connection between the two buffers and the two data signal lines in accordance with reversal of the polarities, in the normal mode, and
connects one of two buffers corresponding to two data signal lines of each set to both of the two data signal lines, and switches the buffer connected with the two data signal lines between the two buffers in accordance with reversal of the polarities, in the power-saving mode.

5. The data signal line drive circuit according to claim 3, wherein the data signal generation unit is configured so as to halt a circuit of at least part of a portion corresponding to generation of an internal data signal to be inputted into a buffer being halted among the plurality of buffers in the power-saving mode.

6. The data signal line drive circuit according to claim 5, wherein
the data signal generation unit includes
a data shift unit configured to receive the image signal as digital data in a serial format and convert the digital data in the serial format to digital data in a parallel format, and
a DA conversion unit configured to convert the digital data in the parallel format to analog data corresponding to the plurality of internal data signals, and
in the power-saving mode, the data signal generation unit halts a circuit of a portion in at least one of the data shift unit and the DA conversion unit, the portion corresponding to generation of an internal data signal to be inputted into the buffer being halted.

7. A display device comprising:
the data signal line drive circuit according to claim 1; and
a scanning signal line drive circuit configured to selectively drive the plurality of scanning signal lines.

8. The display device according to claim 7, wherein
the scanning signal line drive circuit
drives the plurality of scanning signal lines such that the plurality of scanning signal lines are selected one at a time in the normal mode, and
drives the plurality of scanning signal lines such that the plurality of scanning signal lines are selected in a predetermined number of two or more, at a time, and a selection period in which any of the scanning signal lines is selected and a non-selection period in which none of the scanning signal lines is selected alternately appear, in the power-saving mode, and
the output buffer unit is configured so as to halt the plurality of buffers during the non-selection period in the power-saving mode.

9. A display device for displaying a color image based on primary colors in a predetermined number of three or more, the display device comprising:
the data signal line drive circuit according to claim 2; and
a scanning signal line drive circuit configured to selectively drive the plurality of scanning signal lines,
wherein each of pixel formation portions includes a predetermined number of sub-pixel formation portions corresponding to the predetermined number of primary colors and arranged in an extending direction of the scanning signal line,
each of the sub-pixel formation portions corresponds to one of the plurality of data signal lines and corresponds to one of the plurality of scanning signal lines, and
in the power-saving mode, the connection switching circuit connects each of part of the plurality of buffers to a corresponding data signal line and a data signal line that is located adjacent to the corresponding data signal line or within a predetermined range and corresponds to a sub-pixel formation portion of the same color.

10. A display device for displaying a color image based on primary colors in a predetermined number of three or more, the display device comprising:
the data signal line drive circuit according to claim 2;
a scanning signal line drive circuit configured to selectively drive the plurality of scanning signal lines; and
a demultiplexing circuit provided inside or outside the data signal line drive circuit and includes a plurality of demultiplexers corresponding to the plurality of data signals,
wherein each of pixel formation portions includes a predetermined number of sub-pixel formation portions corresponding to the predetermined number of primary colors and arranged in an extending direction of the scanning signal line,
each of the sub-pixel formation portions corresponds to one of the plurality of data signal lines and corresponds to one of the plurality of scanning signal lines,
each of the plurality of data signal lines is connected with a sub-pixel formation portion of one of the predetermined number of primary colors, each data signal line corresponding to one of the predetermined number of primary colors, and
each of the demultiplexers is connected to one set of data signal line group among a plurality of sets of data signal line groups, provides a corresponding data signal to any one data signal line of the one set, and switches the data signal line provided with the corresponding data signal within the one set, the plurality of sets of data signal line groups being obtained by grouping the plurality of data signal lines while regarding a predetermined number of data signal lines that correspond to the predetermined number of primary colors as one set.

11. A method for driving a display device which has at least two operation modes including a normal mode and a power-saving mode, and includes a plurality of data signal lines, a plurality of scanning signal lines that intersect with the plurality of data signal lines, and a plurality of pixel formation portions arranged in a matrix along the plurality of data signal lines and the plurality of scanning signal lines, the method comprising:
a data signal generation step of generating a plurality of internal data signals, which show voltages or currents to be provided to the plurality of data signal lines, based on an externally inputted image signal; and
an output buffer step of outputting the plurality of internal data signals as the plurality of data signals to be applied to the plurality of data signal lines via a plurality of buffers provided so as to correspond to the plurality of data signal lines,
wherein the output buffer step includes
a step of outputting the plurality of data signals to be applied to the plurality of data signal lines from the plurality of buffers in the normal mode, and
a step of operating at least part of the plurality of buffers so as to provide the same data signals to two or a greater predetermined number of pixel formation portions that are adjacent in an extending direction of the data signal line or in an extending direction of the scanning signal line, and halting buffers other than buffers outputting data signals to be applied to any of the plurality of data signal lines among the plurality of buffers, or halting the plurality of buffers in a period in which the plurality of data signals are not applied to the plurality of data signal lines, in the power-saving mode.

12. The driving method according to claim 11, further comprising a connection switching step of switching connection between the plurality of buffers and the plurality of data signal lines,
wherein in the connection switching step,
in the normal mode, each of the plurality of buffers is connected to a corresponding data signal line, and
in the power-saving mode, each of part of the plurality of buffers is connected to a corresponding data signal line and other one or more data signal lines that are adjacent to the corresponding data signal line or within a predetermined range, and
in the output buffer step, among the plurality of buffers, buffers that are not connected to any of the plurality of data signal lines are halted in the power-saving mode.

13. The driving method according to claim 12, wherein
the display device is a display device of an AC drive system,
the plurality of buffers are made up of two types of buffers including a positive-polarity buffer that outputs a positive-polarity data signal and a negative-polarity buffer that outputs a negative-polarity data signal,
in the connection switching step,
the plurality of buffers are connected to the plurality of data signal lines and connection between the plurality of buffers and the plurality of data signal lines is switched in accordance with reversal of polarities of the plurality of data signals to be applied to the plurality of data signal lines such that a polarity of each of the buffers matches a polarity of a data signal to be applied to a data signal line to be connected with the buffer,
in the normal mode, each of the buffers is connected to one data signal line of a corresponding data signal line and other one data signal line that is adjacent to the corresponding data signal line or within a predetermined range, and the data signal line connected with each of the buffers is switched between the corresponding data signal line and the other one data signal line in accordance with reversal of the polarities, and
in the power-saving mode, each of part of the plurality of buffers is connected to a corresponding data signal line and other one or more data signal lines that are adjacent to the corresponding data signal line or within a predetermined range, and the buffer connected to each of the data signal lines is switched between the plurality of buffers in accordance with reversal of the polarities, and
in the output buffer step, among the plurality of buffers, buffers that are not connected to any of the plurality of data signal lines are halted in the power-saving mode.

14. The driving method according to claim 11, further comprising a scanning signal line driving step of selectively driving the plurality of scanning signal lines,
wherein the scanning signal line driving step includes
a step of driving the plurality of scanning signal lines such that the plurality of scanning signal lines are selected one at a time, in the normal mode, and
a step of driving the plurality of scanning signal lines such that the plurality of scanning signal lines are selected in a predetermined number of two or more, at a time, and a selection period in which any of the scanning signal lines is selected and a non-selection period in which none of the scanning signal lines is selected alternately appear, in the power-saving mode, and
in the output buffer step, the plurality of buffers are halted during the non-selection period in the power-saving mode.
